(19) United States
(12) Patent Application Publication
(10) Pub. No.: US 2017/0161840 A1
(43) Pub. Date: Jun. 8, 2017

(54) AUTOMOBILE INSURANCE PREMIUM DETERMINATION SYSTEM AND AUTOMOBILE INSURANCE PREMIUM DETERMINATION METHOD

(71) Applicant: HIGHFREQUENCY VISCOELASTICITY CORPORATION, Kanagawa (JP)

(72) Inventor: Nobuaki OMATA, Kanagawa (JP)

(21) Appl. No.: 15/320,504

(22) PCT Filed: Jul. 8, 2015
(86) PCT No.: PCT/JP2015/003429

§ 371 Date: Dec. 20, 2016

(30) Foreign Application Priority Data
Jul. 10, 2014 (JP) 2014-142268

(51) Int. Cl. G06Q 40/08; G01M 17/02; G01N 19/02

(52) U.S. Cl. CPC G06Q 40/08; G01N 19/02; G01M 17/02

(57) ABSTRACT

An automobile insurance premium determination system (1) according to the present invention includes: a measurement sensor (10) that measures a measurement amount of a viscoelastic characteristic of a tire of an automobile; a viscoelastic characteristic calculation unit (11) that calculates the viscoelastic characteristic of the tire using the measurement amount measured by the measurement sensor (10); a frictional coefficient calculation unit (12) that calculates a frictional coefficient of the tire using the viscoelastic characteristic calculated by the viscoelastic characteristic calculation unit (11); and an insurance premium determination unit (13) that determines an automobile insurance premium based on the frictional coefficient of the tire calculated by the frictional coefficient calculation unit (12).

### TECHNICAL FIELD

The present invention relates to an automobile insurance premium determination system and an automobile insurance premium determination method.

### BACKGROUND ART

Automobile insurance is important to compensate for damages in case of an accident and is in great demand. A large number of methods for calculating insurance premiums have been proposed.

Patent Literature 1, for example, discloses a system of calculating an automobile insurance premium by acquiring and evaluating a status of management of a tire such as an air pressure or the like. In this system, it is regarded that an automobile having a high safety performance in which the air pressure or the like of the tire is frequently managed and an owner of such an automobile are less likely to cause an accident, and thus the insurance premium is reduced. As a technique related to tires, Patent Literature 2 discloses a technique for measuring frictional characteristics in a viscoelastic body such as a tire.

### CITATION LIST

### Patent Literature

[Patent Literature 1] Japanese Unexamined Patent Application Publication No. 2004-145489

[Patent Literature 2] Japanese Unexamined Patent Application Publication No. 2007-47130

### SUMMARY OF INVENTION

### Technical Problem

The air pressure of the tire measured by the aforementioned system that calculates the automobile insurance premium is measured as an index of management of the automobile and it is not a direct index of the safety of the automobile. Even when the air pressure is normal, for example, if the tire is worn or rubber is degraded, the automobile may not be able to stop or decelerate with a normal braking distance. Accordingly, the safety of the automobile may not be appropriately reflected on the calculation of the automobile insurance premium.

The present invention has been made in order to solve the aforementioned problem and aims to provide an automobile insurance premium determination system and an automobile insurance premium determination method capable of determining the automobile insurance premium on which the safety of the automobile is appropriately reflected.

### Solution to Problem

An automobile insurance premium determination system according to a first aspect of the present invention includes a measurement sensor, a viscoelastic characteristic calculation unit, a frictional coefficient calculation unit, and an insurance premium determination unit. The measurement sensor measures a measurement amount of a viscoelastic characteristic of a tire of an automobile. The viscoelastic characteristic calculation unit calculates the viscoelastic characteristic of the tire using the measurement amount measured by the measurement sensor. The frictional coefficient calculation unit calculates a frictional coefficient of the tire using the viscoelastic characteristic calculated by the viscoelastic characteristic calculation unit. The insurance premium determination unit determines an automobile insurance premium based on the frictional coefficient of the tire calculated by the frictional coefficient calculation unit.

An automobile insurance premium determination method according to a second aspect of the present invention includes the following steps (a) to (d):

(a) a measurement step that measures a measurement amount of a viscoelastic characteristic of a tire of an automobile;

(b) a viscoelastic characteristic calculation step that calculates the viscoelastic characteristic of the tire using the measurement amount that has been measured;

(c) a frictional coefficient calculation step that calculates a frictional coefficient of the tire using the viscoelastic characteristic that has been calculated; and

(d) an insurance premium determination step that determines an automobile insurance premium based on the frictional coefficient of the tire that has been calculated.

As stated above, according to the present invention, the frictional coefficient of the tire is calculated based on the viscoelastic characteristic of the tire of the automobile that has been detected in order to determine the automobile insurance premium. Since the reduction in the frictional coefficient of the tire directly causes a decrease in safety and increases the probability of occurrence of an accident, it is possible to appropriately reflect the safety of the automobile on the determination of the automobile insurance premium.

### Advantageous Effects of Invention

According to the present invention, it is possible to provide an automobile insurance premium determination system and an automobile insurance premium determination method capable of determining an automobile insurance premium on which the safety of the automobile is appropriately reflected.

### BRIEF DESCRIPTION OF DRAWINGS

FIG. 1 is a block diagram showing a configuration example of an automobile insurance premium determination system according to a first embodiment;

FIG. 2 is a block diagram showing a configuration example of a measurement sensor and a viscoelastic characteristic calculation unit according to the first embodiment;

FIG. 3A is a diagram for describing a method of calculating a viscoelastic characteristic according to the first embodiment;

FIG. 3B is a diagram for describing a method of calculating the viscoelastic characteristic according to the first embodiment;

FIG. 4 is a block diagram showing a configuration example of a frictional coefficient calculation unit according to the first embodiment;

FIG. 5 is a block diagram showing a configuration example of an insurance premium determination unit according to the first embodiment;

FIG. 6 is a flowchart showing one example of processing of the automobile insurance premium determination system according to the first embodiment;

FIG. 7 is a diagram showing an arrangement example 1 of each component of the automobile insurance premium determination system according to the first embodiment;

FIG. 8 is a diagram showing an arrangement example 3 of each component of the automobile insurance premium determination system according to the first embodiment;

FIG. 9 is a diagram showing one example in which the measurement sensor is provided in a tire of an automobile according to the first embodiment;

FIG. 10 is one example of an in-vehicle device provided in an insured automobile in an arrangement example 4 according to the first embodiment;

FIG. 11 is a block diagram showing a configuration example of an insurance premium determination unit according to a second embodiment; and

FIG. 12 is a block diagram showing a configuration example of an insurance premium determination unit according to a fourth embodiment.

### DESCRIPTION OF EMBODIMENTS

Hereinafter, with reference to the drawings, embodiments of the present invention will be described. Each component of a system shown in the accompanying drawings as functional blocks that perform various types of processing can be formed of a circuit such as a memory or another integrated circuit (IC) in hardware and can be formed of a program or the like loaded to the memory in software.

### First Embodiment

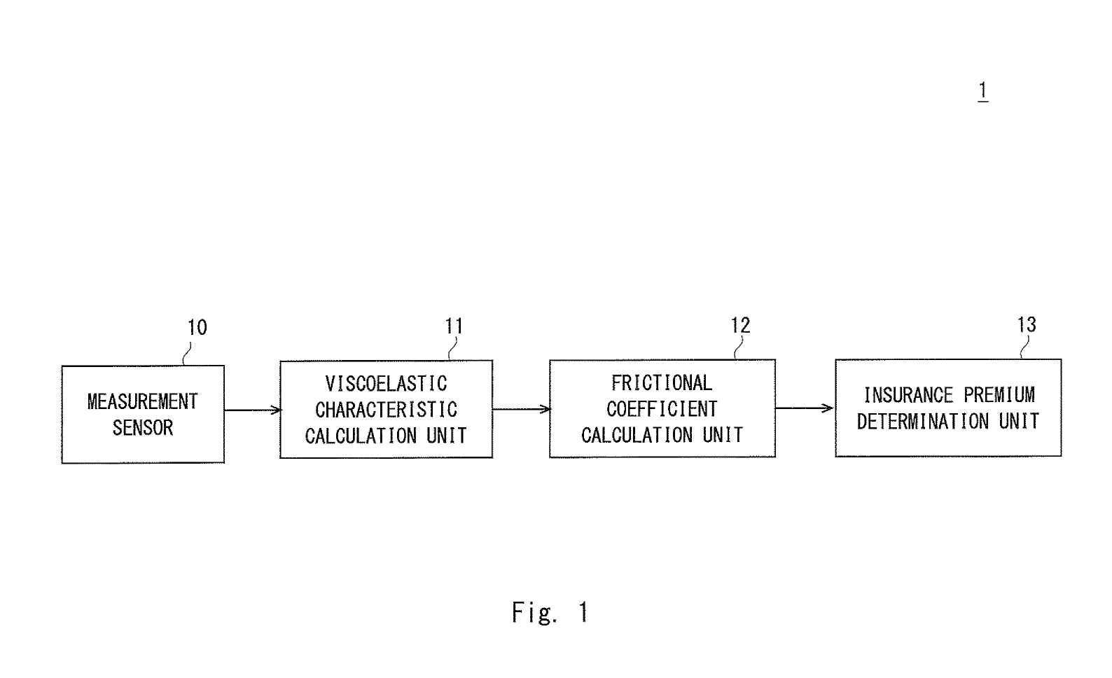

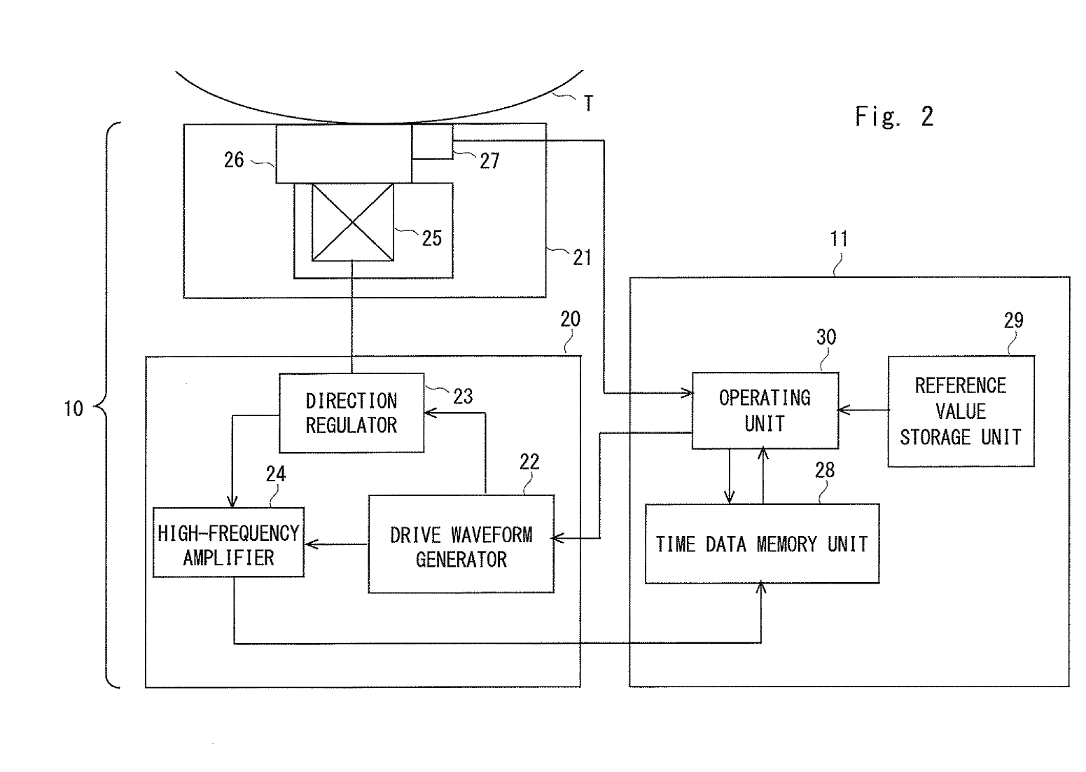

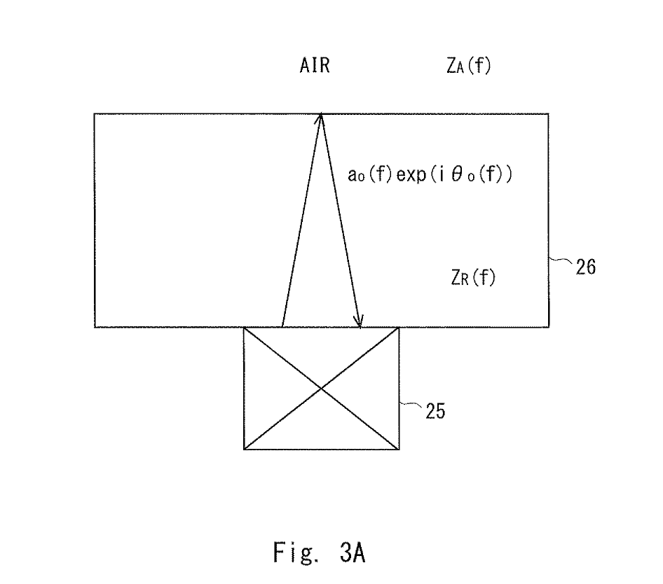

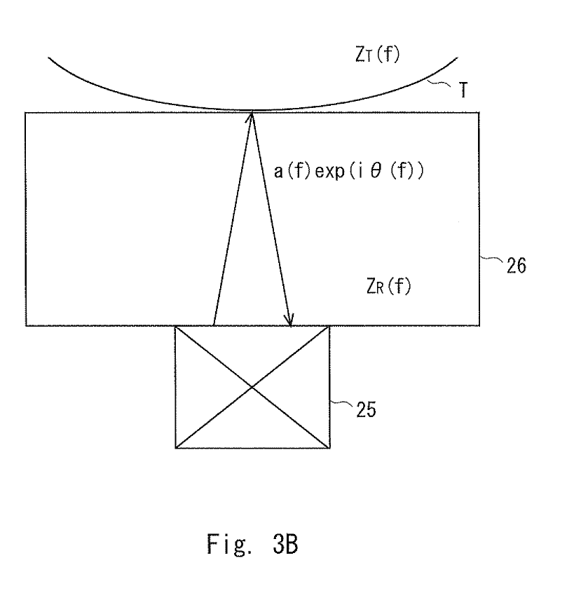

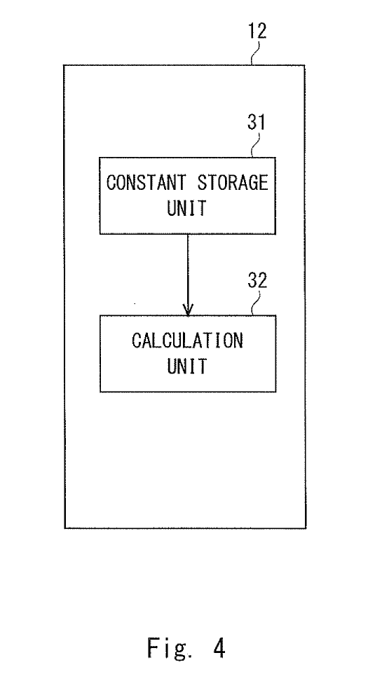

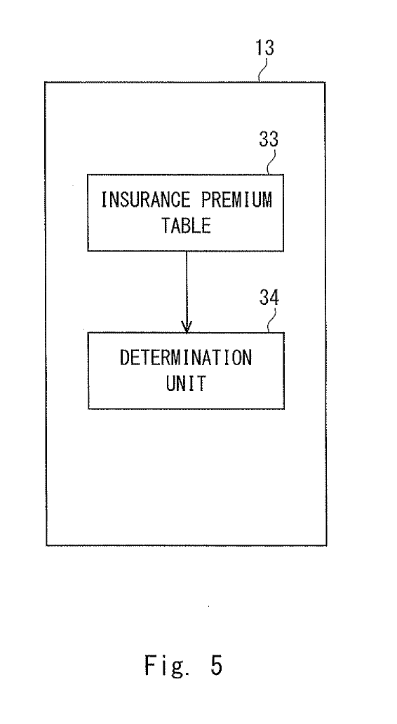

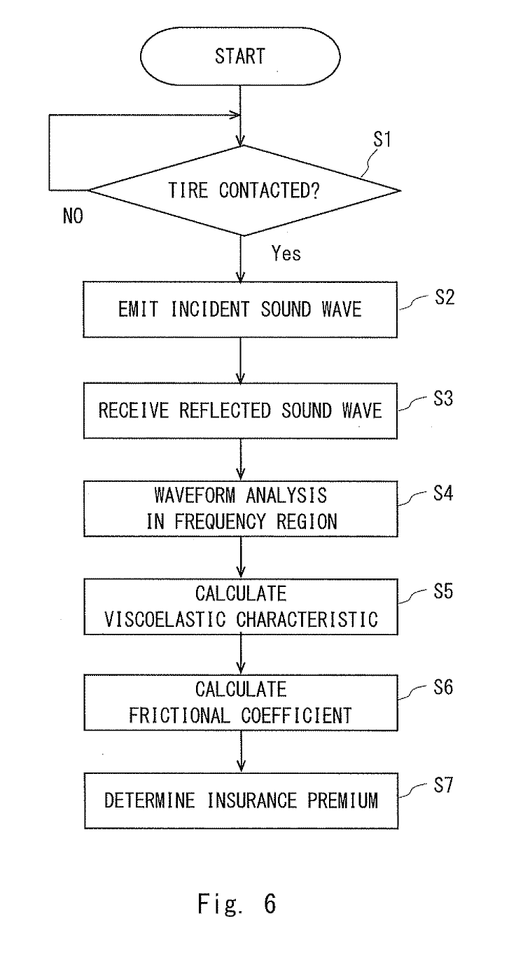

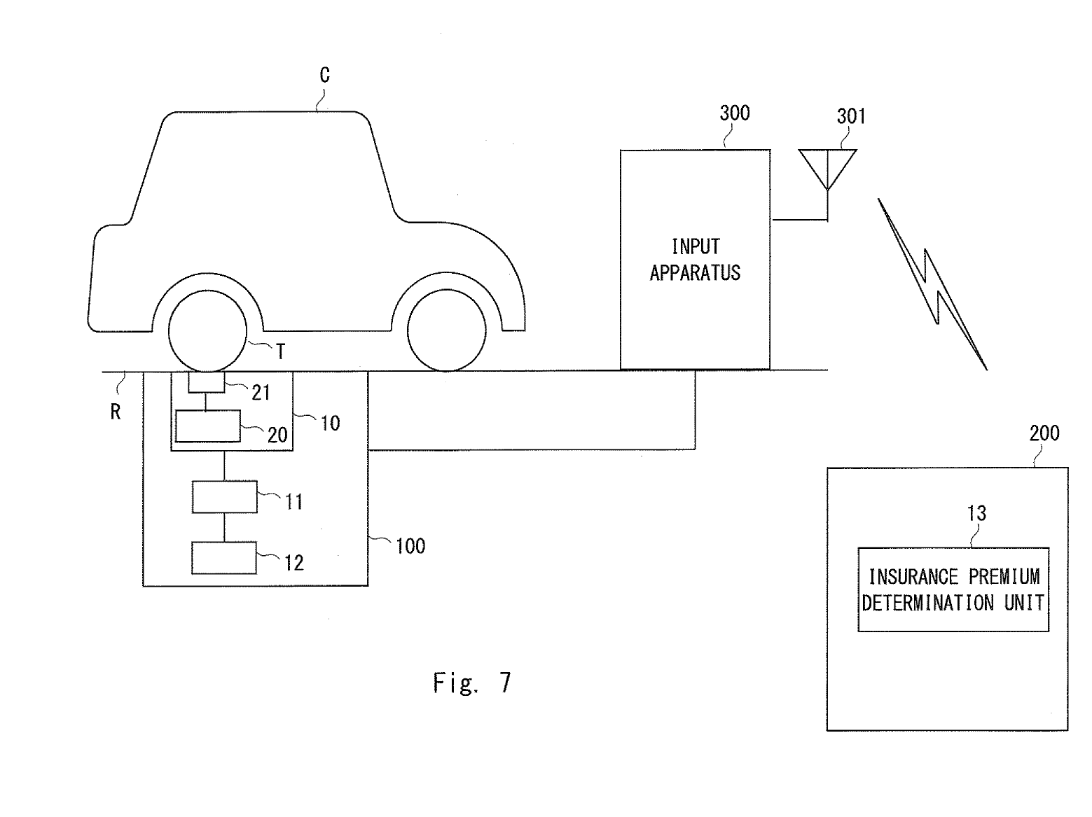

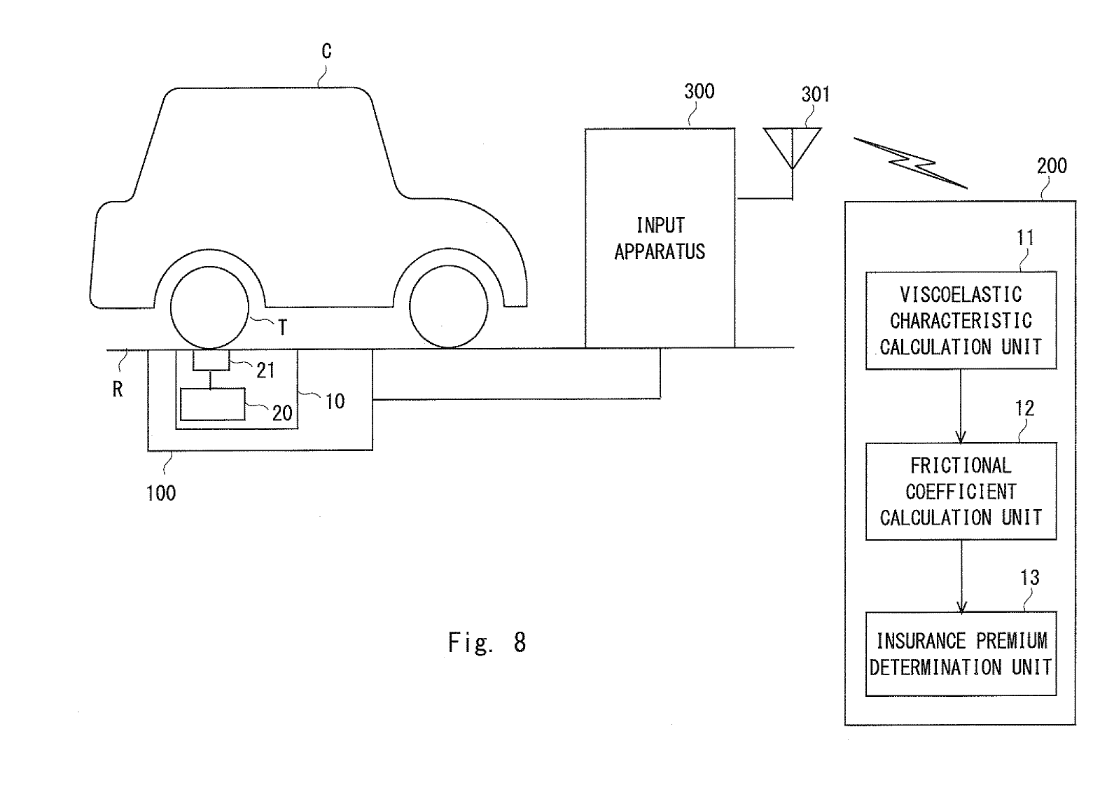

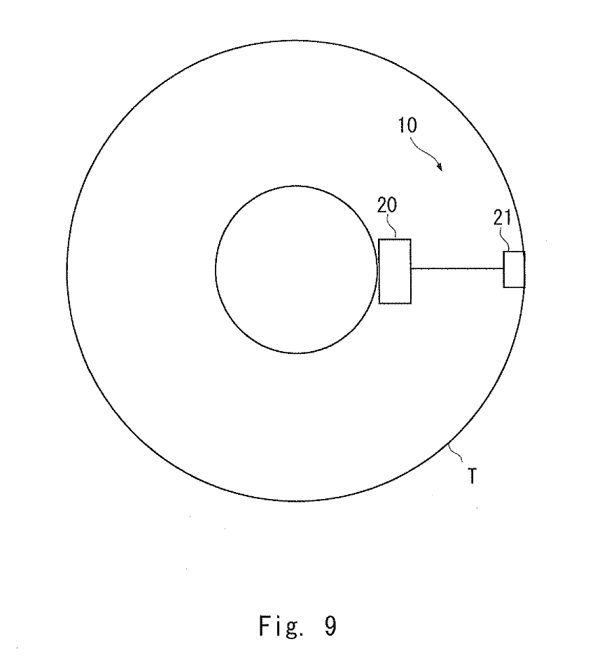

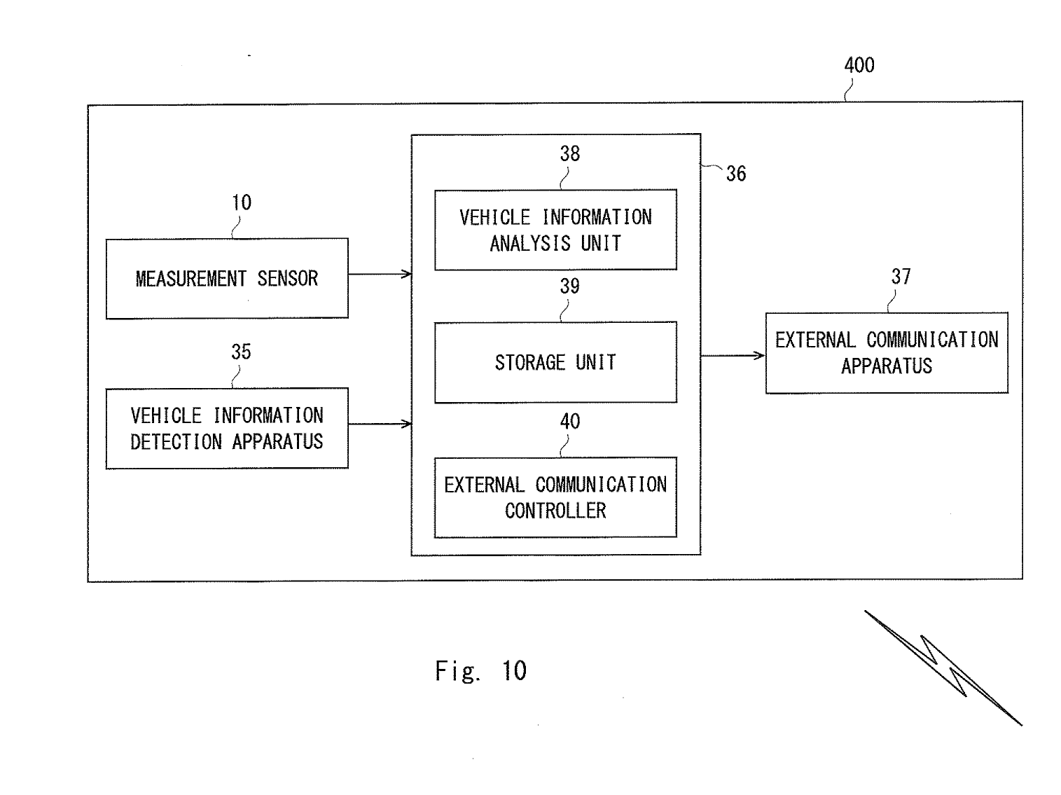

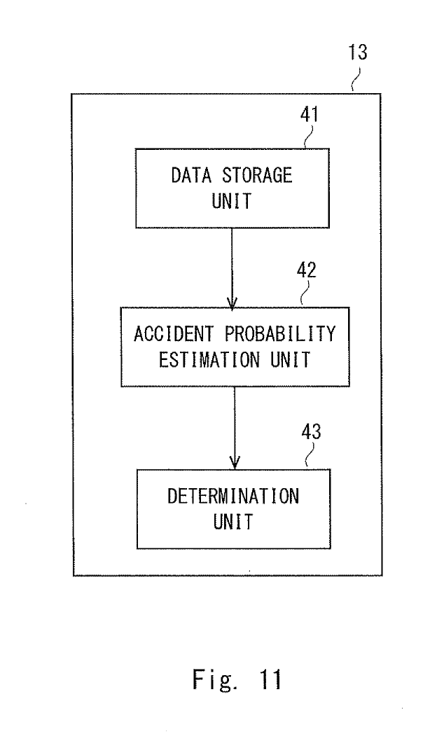

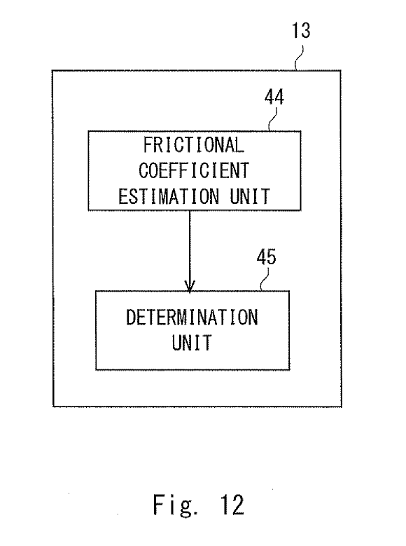

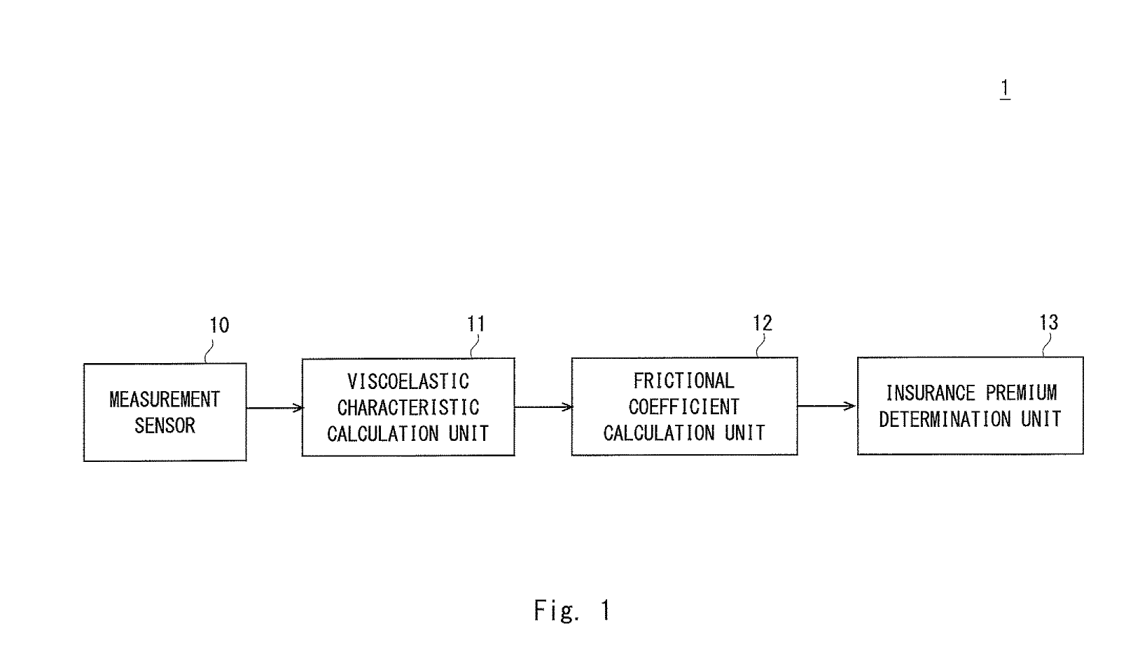

FIG. 1 is a block diagram showing a configuration example of an automobile insurance premium determination system 1 according to a first embodiment. The automobile insurance premium determination system 1 includes a measurement sensor 10, a viscoelastic characteristic calculation unit 11, a frictional coefficient calculation unit 12, and an insurance premium determination unit 13.

The measurement sensor 10 measures a measurement amount of a viscoelastic characteristic of a tire of an automobile whose insurance premium is to be calculated. The tire to be measured is a desired one of a plurality of (e.g., four) tires attached to the automobile. The part of the tire whose viscoelastic characteristic is measured may be any part of the tire. In order to accurately determine a friction deterioration, the viscoelastic characteristic of the tread part of the tire is preferably measured. The viscoelastic characteristic calculation unit 11 calculates the viscoelastic characteristic of the tire using the amount measured by the measurement sensor 10. The measurement sensor 10 may be fixed to a predetermined position or may have a probe shape so that the measurement sensor 10 can be moved to a desired position.

FIG. 2 is a block diagram showing a configuration example of the measurement sensor 10 and the viscoelastic characteristic calculation unit 11. The measurement sensor 10 includes a sound wave signal generation unit 20 and a contact unit 21. The sound wave signal generation unit 20 generates an electric signal of an incident sound wave to calculate the viscoelastic characteristic of a tire T to output the electric signal to the contact unit 21. Further, the sound wave signal generation unit 20 receives the electric signal of a reflected sound wave acquired by the contact unit 21 and outputs the received electric signal to the viscoelastic characteristic calculation unit 11. The contact unit 21 contacts the tire T of the automobile, emits the incident sound wave generated by the sound wave signal generation unit 20 to the tire T, and acquires the reflected sound wave (measurement amount) generated as a result of the reflection of the incident sound wave in the tire T.

The sound wave signal generation unit 20 specifically includes a drive waveform generator 22, a direction regulator 23, and a high-frequency amplifier 24. Hereinafter, each component will be described.

The drive waveform generator 22 generates the electric signal (drive waveform) to generate the sound wave to be emitted to the tire T in accordance with a signal for instructing emission of the sound wave output from the viscoelastic characteristic calculation unit 11 and outputs the electric signal that has been generated to the direction regulator 23. Specifically, the sound wave to be emitted to the tire T may be a pulse-like sound wave or a sound wave that includes a predetermined frequency component. Further, when the drive waveform generator 22 generates the aforementioned electric signal and outputs the generated electric signal, the drive waveform generator 22 outputs a trigger signal indicting the timing when the electric signal that has been generated is to be output to the high-frequency amplifier 24.

The direction regulator 23 is connected to the drive waveform generator 22, the high-frequency amplifier 24, and a transducer 25. The direction regulator 23 outputs the electric signal received from the drive waveform generator 22 to the transducer 25 and outputs the electric signal supplied from the transducer 25 to the high-frequency amplifier 24. The direction regulator 23 adjusts the signal transmission direction in such a way that the electric signal output from the drive waveform generator 22 is not output to the high-frequency amplifier 24.

The high-frequency amplifier 24 amplifies high-frequency components in the electric signal that has been received from the transducer 25 via the direction regulator 23 at a predetermined amplification rate. Then the high-frequency amplifier 24 outputs the electric signal after the amplification to a time data memory unit 28 of the viscoelastic characteristic calculation unit 11. The high-frequency components in the electric signal amplified by the high-frequency amplifier 24 include the measurement amount that is required to calculate the viscoelastic characteristic. After the high-frequency amplifier 24 receives the trigger signal from the drive waveform generator 22, the high-frequency amplifier 24 starts receiving the electric signal supplied from the transducer 25. According to the above processing, the high-frequency amplifier 24 does not perform operations for a period during which the viscoelastic characteristic of the tire T is not measured. It is therefore possible to suppress undesired operations of the high-frequency amplifier 24.

Next, the contact unit 21 will be described. The contact unit 21 specifically includes the transducer 25, a delay member 26, and a contact sensor 27. Hereinafter, each component will be described.

The transducer 25 is formed to include, for example, piezoelectric elements. The transducer 25 is provided in such a way that it contacts the delay member 26. The transducer 25 is connected to the direction regulator 23 and converts, when receiving the electric signal from the drive waveform generator 22 via the direction regulator 23, this electric signal into a sound wave. The sound wave after the conversion is emitted (output) to the tire T via the delay member 26. Further, upon receiving the reflected sound wave (sound wave generated as a result of the reflection of the incident sound wave in the tire T) emitted from the tire T via the delay member 26, the transducer 25 converts the reflected sound wave into the electric signal. The transducer 25 outputs the electric signal after the conversion to the high-frequency amplifier 24 via the direction regulator 23.

From the above description, it can be said that the drive waveform generator 22, the direction regulator 23, and the transducer 25 serve as an emission unit that outputs the incident sound wave to the tire T and the direction regulator 23, the high-frequency amplifier 24, and the transducer 25 serve as a reception unit that receives the reflected sound wave that is generated as a result of the reflection of the incident sound wave in the tire T. Such a configuration is often used in non-destructive inspections (ultrasound waves).

The delay member 26 has one surface that is in close contact with the transducer 25 and another surface opposed to the surface that contacts the tire T. According to such a configuration, the delay member 26 is able to propagate the incident sound wave emitted from the transducer 25 to the tire T and to propagate the reflected sound wave that is generated as a result of the reflection of the incident sound wave in the tire T to the transducer 25. In the delay member 26, by delaying the arrival time of the sound wave by the propagation length of the delay member 26, a time from the emission of the incident sound wave by the transducer 25 until the reception of the reflected sound wave by the transducer 25 can be increased. It is therefore possible to prevent the transducer 25 from receiving the reflected sound wave while it is emitting the incident sound wave.

The contact sensor 27 detects a contact of the tire T with the delay member 26 and outputs a detection signal to an operating unit 30. When the delay member 26 is provided on a road surface, for example, the contact sensor 27 is provided in the vicinity of the delay member 26.

Next, the viscoelastic characteristic calculation unit 11 will be described. The viscoelastic characteristic calculation unit 11 specifically includes the time data memory unit 28, a reference value storage unit 29, and the operating unit 30. Hereinafter, each component will be described.

The time data memory unit 28 stores a time waveform of the electric signal of the reflected sound wave supplied from the high-frequency amplifier 24 of the measurement sensor 10 at a predetermined cycle. The time data memory unit 28 is able to change the cycle at which the time waveform is stored based on control by the operating unit 30.

The reference value storage unit 29 stores a reference value that is necessary to calculate the viscoelastic characteristic of the tire T in advance. This reference value is data of an amplitude value and a phase at the frequency at which the viscoelastic characteristic is detected. The details of the reference value will be described later. The reference value stored in the reference value storage unit 29 is read out by the operating unit 30.

The operating unit 30 controls data measurement processing of the measurement sensor 10 and calculates the viscoelastic characteristic of the tire T based on the reflected sound wave acquired by the measurement by the measurement sensor 10.

Specifically, when the operating unit 30 receives the detection signal from the contact sensor 27, the operating unit 30 determines that the tire T has come into contact with the delay member 26 of the measurement sensor 10 and outputs an instruction to emit the sound wave to the drive waveform generator 22. As described above, the drive waveform generator 22 generates the electric signal to generate the sound wave to be emitted to the tire T in accordance with the instruction to emit the sound wave and outputs the electric signal to the direction regulator 23. In this way, the operating unit 30 allows the measurement sensor 10 to start measurement when the tire T comes in contact with the delay member 26.

When the measurement sensor 10 executes measurement of the tire T and time waveform data of the reflected sound wave is stored in the time data memory unit 28, the operating unit 30 reads out this data. The operating unit 30 performs waveform analysis processing in a frequency region such as, for example, Fast Fourier Transformation (FFT) processing to acquire the amplitude value and the phase at the frequency to be detected. The number of frequencies to be detected may either be one or plural. Next, the operating unit 30 reads out the reference value stored in the reference value storage unit 29 and calculates the viscoelastic characteristic of the tire T based on the reference value and the amplitude value and the phase of the reflected sound wave stored in the time data memory unit 28 at the frequency to be detected.

### <Method of Calculating Viscoelastic Characteristic>

Next, calculation of the viscoelastic characteristic of the tire T executed by the measurement sensor 10 and the viscoelastic characteristic calculation unit 11 will be described. In this calculation method, a surface reflection method in which the measurement sensor 10 emits the incident sound wave to the tire T and the viscoelastic characteristic calculation unit 11 measures the viscoelastic characteristic (in particular, a loss tangent) based on the reflected sound wave generated as a result of reflection of the incident sound wave in the surface of the tire T is used (see, for example, Patent Literature 2).

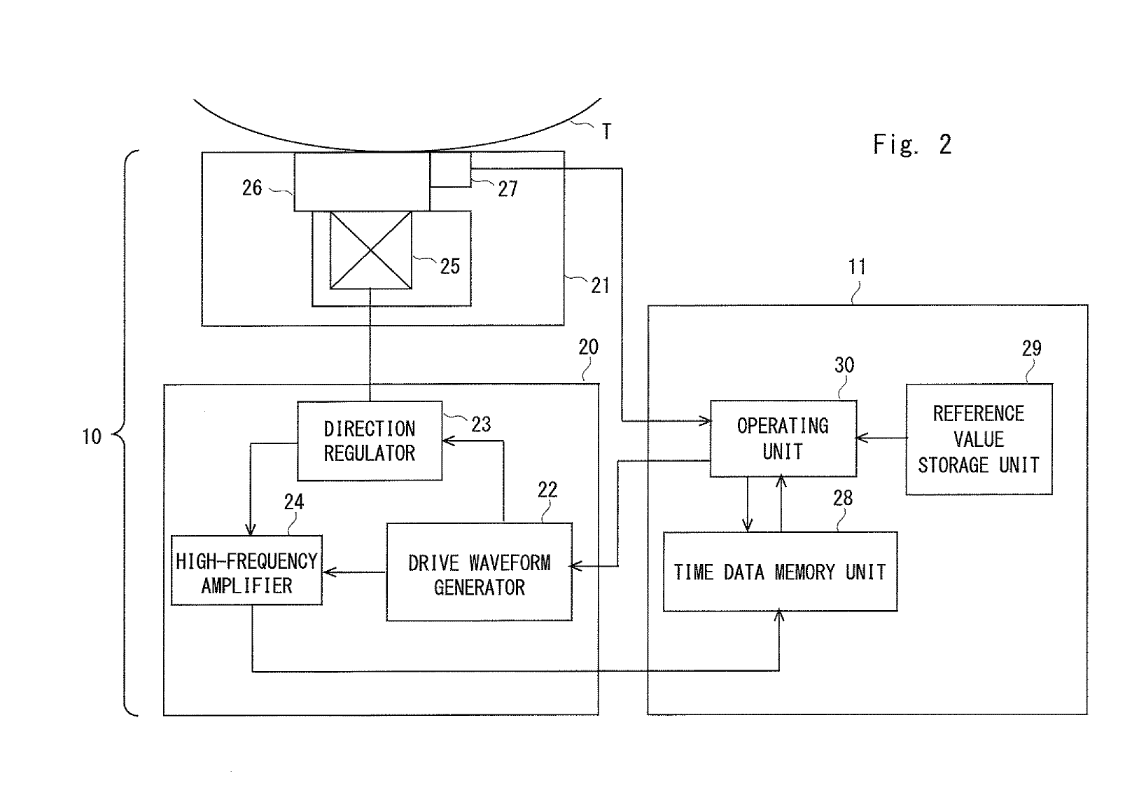

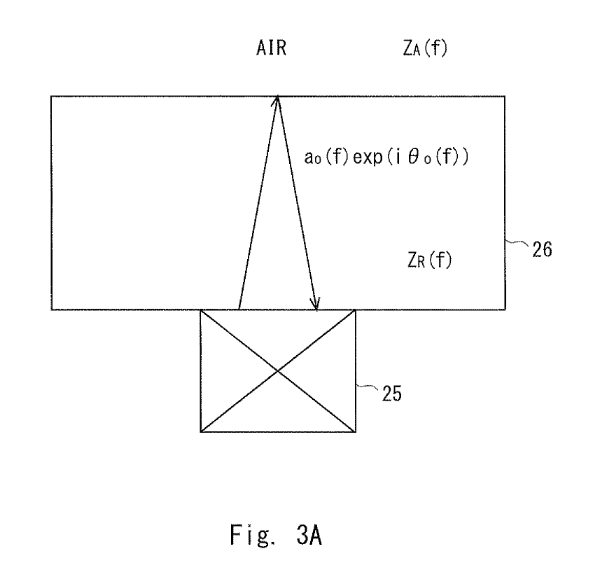

FIGS. 3A and 3B are diagrams for describing the method of calculating the viscoelastic characteristic using this surface reflection method. FIG. 3A is a diagram showing the reflection status of the incident sound wave when the reference value is acquired and FIG. 3B is a diagram showing the reflection status of the incident sound wave when the viscoelastic characteristic of the tire T is calculated. In the following description, an acoustic impedance that indicates the propagation characteristic of the incident sound wave emitted from the transducer 25 of the measurement sensor 10 is used.

Referring first to FIG. 3A, the reference value will be described. The reference value is a phase and an amplitude value at the frequency to be measured when the surface of the delay member 26 opposite to the surface that the transducer 25 contacts does not contact the tire T. In this case, the incident sound wave is reflected on the interface between an end of the delay member 26 and the air. When the frequency of the incident sound wave and the reflected sound wave is denoted by f, the acoustic impedance of the delay member 26 can be expressed by Z_{R}(f), which is a function of the frequency f. In a similar way, the acoustic impedance in the air can be expressed by Z_{A}(f), which is a function of the frequency f. The acoustic impedances Z_{R}(f) and Z_{A}(f) are complex values.

A reflectance R_{AR}(f) of the incident sound wave in the interface between the delay member 26 and the air is as follows.

R_{AR}(f)=(Z_{A}(f)−Z_{R}(f))/(Z_{A}(f)+Z_{R}(f)) (1)

In this case, at a desired frequency f, Z_{A}(f) is much smaller than Z_{R}(f). Therefore, from Expression (1), the reflectance R_{AR}(f) becomes −1. That is, the entire incident sound wave is reflected on the interface between the delay member 26 and the air.

In the following description, the expression of the reflected sound wave that is incident on the transducer 25 is expressed by a₀(f)exp(iθ₀(f)). The symbol i denotes an imaginary unit, the symbol a₀(f) denotes an amplitude value of a real number at the target frequency, and the symbol θ₀(f) is a real number equal to or larger than 0 and indicates the phase at each frequency. The expression of the incident sound wave emitted from the measurement sensor 10 to the tire T via the delay member 26 is expressed as follows.

a₀(f)exp(iθ₀(f))×R_{AR}(f)=−a₀(f)exp(iθ₀(f)) (2)

It can therefore be regarded that the incident sound wave shown in Expression (2) is emitted to the tire T. The reference value storage unit 29 stores the amplitude a₀(f) and the phase θ₀(f) in Expression (2) as a reference value in advance. This reference value is measured and obtained in advance.

With reference next to FIG. 3B, the calculation of the viscoelastic characteristic of the tire T will be described. When the viscoelastic characteristic of the tire T is calculated, in a state in which the delay member 26 is in close contact with the tire T, the incident sound wave the same as that shown in FIG. 3A is emitted from the transducer 25 according to the output of the electric signal from the drive waveform generator 22. The transducer 25 receives the reflected sound wave reflected on the interface between the delay member 26 and the tire T and the high-frequency amplifier 24 amplifies the high-frequency components in the electric signal of the reflected sound wave. The operating unit 30 compares the reflected sound wave with the reference value stored in the reference value storage unit 29 to calculate the loss tangent of the tire T.

When the acoustic impedance of the tire T, which is a function of the frequency f, is denoted by Z_{T}(f), a reflectance R_{RT}(f) of the incident sound wave in the interface between the delay member 26 and the tire T is expressed by the following expression.

R_{RT}(f)=(Z_{T}(f)−Z_{R}(f))/(Z_{T}(f)+Z_{R}(f)) (3)

From Expression (3), Z_{T}(f) is expressed as follows.

Z_{T}(f)=Z_{R}(f)×(1+R_{RT}(f))/(1−R_{RT}(f)) (4)

In the following description, the expression of the reflected sound wave incident on the transducer 25 is expressed by a(f)exp(iθ(f)). The symbol i indicates an imaginary unit, the symbol a(f) indicates an amplitude value of a real number at the target frequency, and the symbol θ(f) is a real number equal to or larger than 0 and indicates the phase at each frequency. Using the reference value in Expression (2), the expression of the reflected sound wave is expressed by the following expression.

a(f)exp(iθ(f))=−a₀(f)exp(iθ₀(f))×R_{RT}(f) (5)

From Expression (5), the reflectance R_{RT}(f) of the incident sound wave is expressed by the following expression.

R_{RT}(f)=−(a(f)/a₀(f))exp(i(θ(f)−θ₀(f)) (6)

When Expression (6) is substituted into Expression (4), Z_{T}(f) can be obtained as follows.

Z_{T}(f)=Z_{R}(f)×(1−(a(f)/a₀(f))×exp(i(θ(f)−θ₀(f)))/(1+(a(f)/a₀(f))×exp(i(θ(F)−θ₀(f))) (7)

The storage elastic modulus and the loss elastic modulus of the tire T, which is a function of the frequency f, are respectively denoted by E′(f) and E″(f). In this case, the following relation is established between E′(f) and E″(f) and the acoustic impedance Z_{T}(f) and the density ρ_{T} of the tire T.

E′(f)+iE″(f)=Z_{T}(f)²/ρ_{T} (8)

By substituting Expression (7) into Expression (8) and separating the real number component and the imaginary number component, a loss tangent tan δ(f) is calculated as follows.

tan δ(f)=E″(f)/E′(f)={4×(a(f)/a₀(f))×(1−(a(f)/a₀(f))²)×sin(θ(f)−θ₀(f))}/{(1−(a(f)/a₀(f))²)²−4×(a(f)/a₀(f))²×sin²(θ(f)−θ₀(f))} (9)

The storage elastic modulus E′(f) and the loss elastic modulus E″(f) are respectively calculated as follows.

E′(f)=Re[Z_{T}(f)²/ρ_{T}]=(Z_{R}(f)²/ρ_{T})×{(1−(a(f)/a₀(f))²)²−4(a(f)/a₀(f))²×sin²(θ(f)−θ₀(f))}/{1+2(a(f)/a₀(f))cos(θ(f)−θ₀(f))+(a(f)/a₀(f))²}² (10)

E″(f)=Im[Z_{T}(f)²/ρ_{T}]=(Z_{R}(f)²/ρ_{T})×{4(a(f)/a₀(f))×(1−(a(f)/a₀(f))²)sin(θ(f)−θ₀(f))}/{1+2(a(f)/a₀(f))cos(θ(f)−θ₀(f))+(a(f)/a₀(f))²}² (11)

The symbol Re[Z_{T}(f)²/ρ_{T}] indicates the real number component of Z_{T}(f)²/ρ_{T} and the symbol Im[Z_{T}(f)²/ρ_{T}] indicates the imaginary number component of Z_{T}(f)²/ρ_{T}.

As shown in Expressions (9) to (11), the storage elastic modulus E′(f), the loss elastic modulus E″(f), and the loss tangent tan δ(f) are all defined by {a(f)/a₀(f)} and {θ(f)−θ₀(f)} based on a₀(f) and θ₀(f). Accordingly, by comparing data of the electric signal of the reflected sound wave acquired when the tire T is measured with the amplitude a₀(f) and the phase characteristic θ₀(f) used as a reference value, the viscoelastic characteristic (in particular, the loss tangent) of the tire T can be measured. Further, as stated above, the loss tangent of the tire T depends on the frequency. Accordingly, the measurement sensor 10 may calculate the loss tangent for each of the plurality of frequency components. Further, when it is required to calculate the loss tangent at a high frequency, ultrasound waves may be supplied from the transducer 25 as the incident sound wave.

Referring back to FIG. 1, the description of the automobile insurance premium determination system 1 will be continued. The frictional coefficient calculation unit 12 calculates the frictional coefficient of the tire T using the viscoelastic characteristic of the tire T calculated by the viscoelastic characteristic calculation unit 11. The frictional coefficient μ(f) of the tire T, which is a function of the frequency f, can be expressed as the following expression using the aforementioned loss tangent tan δ(f) and the storage elastic modulus E′(f).

μ(f)=α×E′(f)ⁿ×tan δ(f)+β (12)

The symbols α(>0) and β are unique constants that vary depending on the type of the tire (e.g., material of the tire) and n is a predetermined real number (e.g., n=−⅓). The expression to obtain the frictional coefficient μ(f) may be a polynomial expression or a high-degree expression using tan δ(f) other than Expression (12). By calculating the frictional coefficient μ(f), it is possible to detect the magnitude of a grip force specific to the tire that does not depend on the state of the road surface. The constants α and β are values acquired by experiments or the like in advance. The constants α and tan δ(f), in particular, are highly correlated with the frictional coefficient when it rains (under a wet condition). It is needless to say that the magnitude of the frictional coefficient under a wet condition has a close relation to an accident rate.

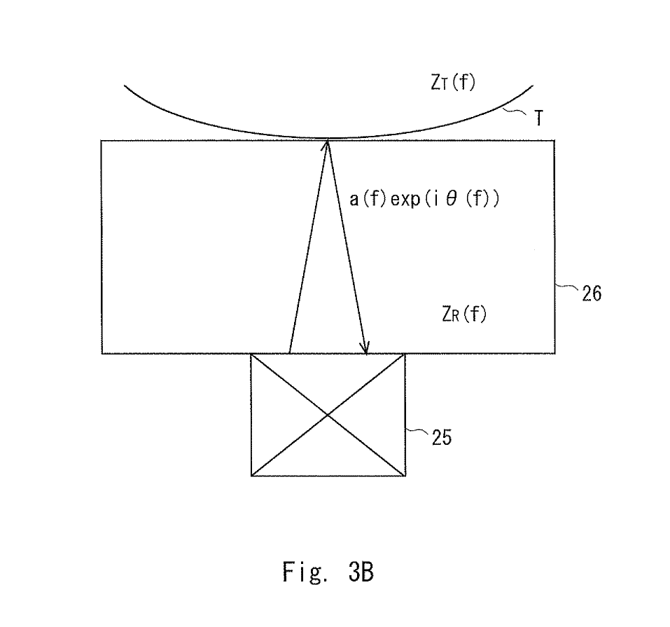

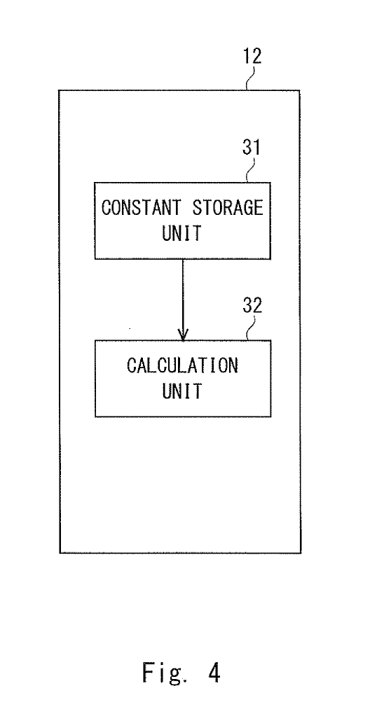

FIG. 4 is a block diagram showing a configuration example of the frictional coefficient calculation unit 12. The frictional coefficient calculation unit 12 specifically includes a constant storage unit 31 and a calculation unit 32. The constant storage unit 31 stores the aforementioned α and β. The calculation unit 32 calculates the frictional coefficient μ(f) of the tire T from Expression (12) based on the loss tangent tan δ(f) and the storage elastic modulus E′(f) calculated by the viscoelastic characteristic calculation unit 11 using the constants α and β stored in the constant storage unit 31.

The insurance premium determination unit 13 shown in FIG. 1 determines the insurance premium of the target automobile based on the frictional coefficient of the tire T calculated by the frictional coefficient calculation unit 12. This expression of calculating the insurance premium is determined, for example, based on an economic motive of an insurance company. As the frictional coefficient of the tire T becomes smaller, it becomes difficult for the automobile to make a sudden stop, which makes the automobile become more vulnerable to danger. Accordingly, the insurance premium determination unit 13 calculates the insurance premium so that the insurance premium becomes higher as the frictional coefficient of the tire T becomes smaller.

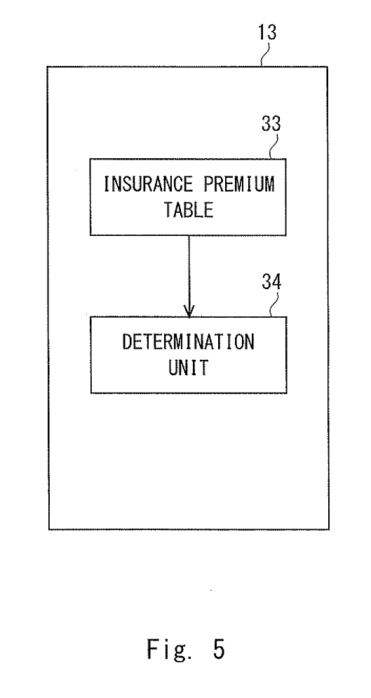

FIG. 5 is a block diagram showing a configuration example of the insurance premium determination unit 13. The insurance premium determination unit 13 specifically includes an insurance premium table 33 and a determination unit 34. The insurance premium table 33 stores a table in which the frictional coefficient of the tire and other information and the amount of money of the insurance premium are associated with each other. The “other information” includes, for example, characteristics of the tire other than the viscoelastic characteristic or information on the user of the automobile (e.g., information indicating the safety level of driving by the user (such as whether the user has a superior driver's license or a superior driving record)), that become a factor in determining the insurance premium. The determination unit 34 determines the insurance premium of the target automobile by referring to the insurance premium table 33 based on the frictional coefficient of the tire T calculated by the frictional coefficient calculation unit 12 and the other information and acquiring the amount of money of the insurance premium corresponding to this frictional coefficient.

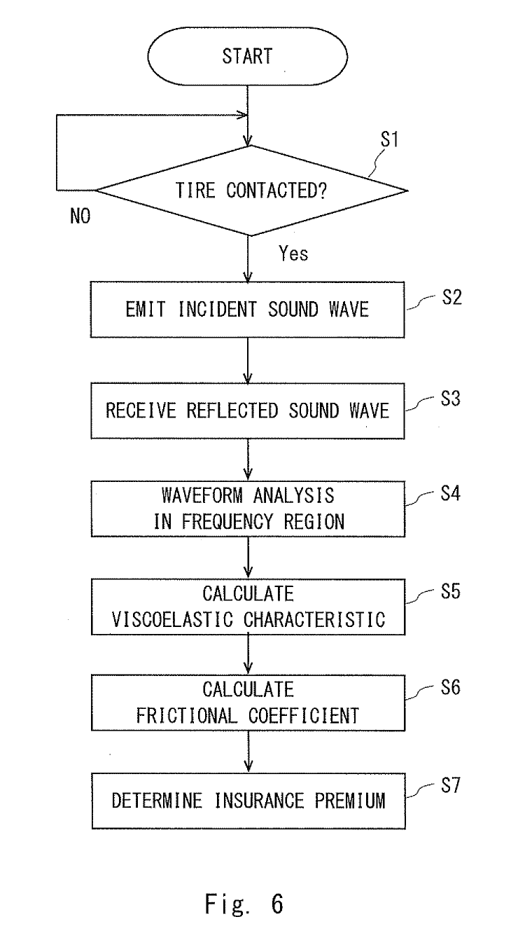

FIG. 6 is a flowchart showing one example of processing of the automobile insurance premium determination system 1. In the following description, with reference to FIG. 6, the whole processing of the automobile insurance premium determination system 1 will be described.

First, the operating unit 30 determines whether it has received the detection signal indicating that the tire T has come into contact with the delay member 26 from the contact sensor 27 (Step S1). When the operating unit 30 has not received the detection signal (No in Step S1), the operating unit 30 does not cause the measurement sensor 10 to execute the measurement processing and performs the determination processing in Step S1 again.

When the operating unit 30 has received the detection signal (Yes in Step S1), the operating unit 30 outputs an instruction to emit the sound wave to the drive waveform generator 22. The drive waveform generator 22 generates the electric signal to generate the sound wave to be emitted to the tire T in response to the instruction and outputs the electric signal to the transducer 25 via the direction regulator 23. The transducer 25 converts the electric signal that has been supplied into the incident sound wave and emits the incident sound wave to the tire T via the delay member 26 (Step S2).

Upon receiving the reflected sound wave from the tire T via the delay member 26, the transducer 25 converts the reflected sound wave into an electric signal and outputs the electric signal after the conversion to the high-frequency amplifier 24 via the direction regulator 23 (Step S3). The high-frequency amplifier 24 amplifies the high-frequency components included in the electric signal that has been supplied and outputs the electric signal that has been amplified to the time data memory unit 28.

The operating unit 30 reads out the data stored in the time data memory unit 28, performs waveform analysis processing in a frequency region, and acquires the amplitude value and the phase in the frequency to be detected (Step S4). Next, the operating unit 30 reads out the reference value stored in the reference value storage unit 29. The operating unit 30 calculates the viscoelastic characteristic of the tire T based on the reference value and the amplitude value and the phase of the reflected sound wave stored in the time data memory unit 28 at the frequency to be detected (Step S5). The details of this calculation method have already been described above.

The frictional coefficient calculation unit 12 calculates the frictional coefficient of the tire T using the viscoelastic characteristic of the tire T calculated by the viscoelastic characteristic calculation unit 11 (Step S6). The insurance premium determination unit 13 determines the insurance premium of the target automobile based on the frictional coefficient of the tire T calculated by the frictional coefficient calculation unit 12 (Step S7).

As described above, in the present invention, the frictional coefficient of the tire is calculated based on the viscoelastic characteristic of the tire of the automobile that has been detected in order to determine the automobile insurance premium. Since it is considered that the reduction in the frictional coefficient of the tire directly causes a reduction in the safety, increases the probability of occurrence of an accident, and causes severe damage, by employing the present invention, it becomes possible to appropriately reflect the safety of the automobile on the insurance premium when the automobile insurance premium is determined. It is possible, for example, to evaluate the safety of the automobile such as whether the automobile is able to stop in time, by braking, to prevent an unexpected danger from occurring during driving. Further, since the performance of the automobile becomes the important factor in calculating the insurance premium in the automobile insurance, the insurance premium can be appropriately set according to the present invention. Further, since it is sufficient to cause the sensor to come into contact with the tire of the automobile in the inspection process, the inspection process can be performed in a simple manner without taking much time and causing any trouble.

Further, an automobile that is equipped with an antilock brake system (ABS), which is eligible for a discount on the insurance premium, can be prevented from sideslipping by preventing the tire from being locked when hard braking is applied. However, if the frictional coefficient is small due to the degradation of the tire, the braking distance inevitably becomes long. According to the present invention, however, the safety of the automobile that is equipped with the ABS can be evaluated more appropriately to calculate the insurance premium of such an automobile. In a utility form of an automobile such as a rental automobile or automobile sharing, a large number of unspecified users drive the automobile. In such a case, the performance of the automobile, not driving techniques of the users, becomes the factor in calculating the insurance premium. In such a utility form as well, according to the present invention, it is possible to appropriately calculate the insurance premium. Even in a case in which an automated driving device/system mounted on an automobile performs automatic driving, the automobile insurance premium can be determined in a way similar to the case in which the user drives the automobile.

Hereinafter, arrangement examples of each component of the automobile insurance premium determination system 1 will be described.

### Arrangement Example 1

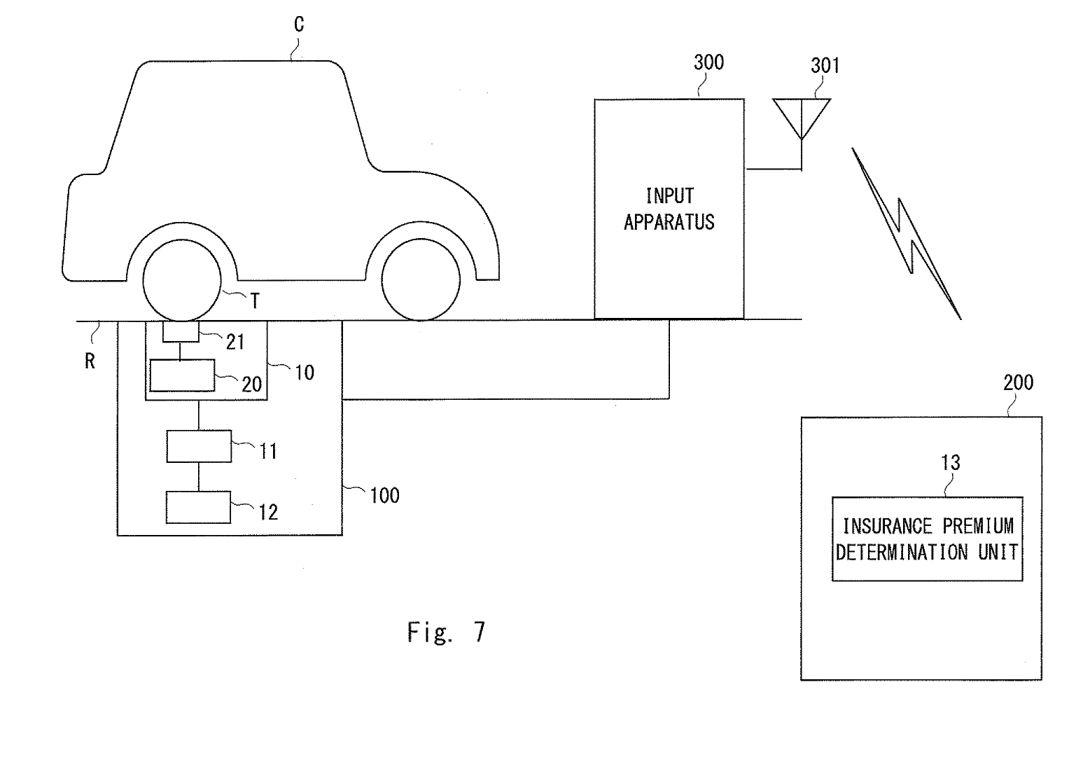

FIG. 7 is a diagram showing an arrangement example 1 of each component of the automobile insurance premium determination system 1. In the arrangement example 1, the measurement sensor 10, the viscoelastic characteristic calculation unit 11, and the frictional coefficient calculation unit 12 shown in FIG. 1 are arranged in a measurement apparatus 100 and the insurance premium determination unit 13 is arranged in a server 200. The measurement apparatus 100 is arranged on a road surface R. An input apparatus 300 is connected to the measurement apparatus 100. The server 200 is arranged in a position spaced apart from the measurement apparatus 100 and the input apparatus 300. The measurement apparatus 100 and the input apparatus 300 are located in a position such as a parking area, a gas station, a drive-through area of a hamburger shop or the like where an automobile C stops. The measurement apparatus 100 and the input apparatus 300 may be provided not only in a public parking space but also in a parking area (or a parking position) for users of shops such as a convenience store, a supermarket, an automobile dealer, a shop for automobile parts such as tires, or an automobile maintenance facility. The server 200 is, for example, a server owned by the insurance company of the automobile.

The input apparatus 300 is provided in the vicinity of the measurement apparatus 100 and includes an input device such as a touch panel or buttons, or a display. The user is able to operate the input device and to input personal identification information such as the name of the user, the license number, the type of the automobile, the number of the number plate by which the user and the automobile can be identified into the input apparatus 300. The user is also able to input the aforementioned “other information”, which becomes a factor other than the viscoelastic characteristic in determining the insurance premium, into the input apparatus 300.

Further, the data of the frictional coefficient calculated in the frictional coefficient calculation unit 12 is supplied to the input apparatus 300. The input apparatus 300 transmits the data of the frictional coefficient that has been supplied and the personal identification information and the other information input by the user to the server 200 using a radio transmission unit 301. The input apparatus 300 may transmit the data by a wire, not wirelessly.

The insurance premium determination unit 13 of the server 200 calculates the automobile insurance premium measured by the measurement apparatus 100 based on the data of the frictional coefficient and the other information that have been received. Further, the server 200 performs a procedure for applying for the automobile insurance of the user based on the personal identification information that has been input. The insurance premium determination unit 13 determines the insurance premium of the user using the frictional coefficient measured by the measurement apparatus 100. The server 200 transmits the insurance premium that has been calculated to the input apparatus 300. The input apparatus 300 displays the insurance premium that has been transmitted from the server 200 on a display or the like. Accordingly, the user is able to check the insurance premium immediately after the measurement of the frictional coefficient of the tire is completed.

Further, the user of the automobile may check the insurance premium by accessing the server 200 from another terminal. When the user accesses the server 200, the server 200 requires the user to input, for example, the personal identification information of the user via the terminal. When the personal identification information that has been input coincides with the personal identification information stored in the server 200, the server 200 displays the insurance premium associated with the personal identification information on its terminal.

There may be a plurality of measurement apparatuses 100 corresponding to one input apparatus 300. In this case, the input apparatus 300 may require the user to input information indicating in which one of the plurality of measurement apparatuses 100 the automobile of the user is being measured. The input apparatus 300 transmits, based on this information, the frictional coefficient measured by the measurement apparatus 100 that has been selected to the server 200.

Further, a monitoring camera may be provided near the road surface R where the measurement apparatus 100 is provided. The monitoring camera captures an image of the number plate of the automobile stopped on the road surface R and transmits the image of the number plate that has been captured to the server 200 using the radio transmission unit 301.

The insurance premium determination unit 13 recognizes the number plate of the automobile in the image captured by the monitoring camera. Further, the insurance premium determination unit 13 acquires the personal identification information input by the user into the input apparatus 300 connected to the measurement apparatus 100 corresponding to this monitoring camera and acquires information on the number plate included in the personal identification information. The insurance premium determination unit 13 determines whether information on one of the two number plates is identical to that of the other one of the two number plates, and performs processing for determining the insurance premium when the information on one of the two number plates is identical to that of the other one of the two number plates. When the information on one of the two number plates is different from that of the other one of the two number plates, the insurance premium determination unit 13 does not perform the processing of determining the insurance premium. The server 200 displays, for example, an error on the display of the input apparatus 300. As described above, by providing the monitoring camera, it is possible to prevent a false input or an unauthorized input by the user in the processing of determining the insurance premium.

As shown in Expression (12), in order to accurately calculate the frictional coefficient μ of the tire, it is preferable to accurately determine the constants α, β, tan δ, and E′ that depend on the type of the tire. The type of the tire varies depending on the type of the automobile. The material of the tire is considered to change, for example, depending on the size of the tire. That is, automobiles having different sizes have tires made of different materials (for example, the material of the tire of a standard automobile and that of a large-sized vehicle such as a truck are different from each other). Further, the material of the tire varies depending on the manufacturing company or the model number of the tire. Therefore, in order to calculate the frictional coefficient μ of the tire, it is preferable that information on the type of the tire such as the application, the manufacturing company, and the model number of the tire be correctly input into the computer 200.

As a first example, the user may input the type of the tire from the input apparatus 300. The input apparatus 300 outputs information on the type of the tire that has been input to the measurement apparatus 100. The constant storage unit 31 (see FIG. 4) of the measurement apparatus 100 stores a number of pairs of the constants α and β associated with the types of the tires. The number of pairs of the constants α and β to be stored in the constant storage unit 31 is the same as the number of types of the tires. The calculation unit 32 selects the constants α and β in accordance with the information on the type of the tire output from the input apparatus 300 and calculates the frictional coefficient μ of the tire using the constants α and β that have been selected and tan δ and E′ calculated by the viscoelastic characteristic calculation unit 11. In this way, the measurement apparatus 100 is able to correctly determine the constants in accordance with the type of the tire.

As a second example, the measurement apparatus 100 may further include a device that detects the type of the tire. When this device detects the type of the tire, the calculation unit 32 selects the constants α and β corresponding to the tire that has been measured from the plurality of constants α and β stored in the constant storage unit 31 in accordance with the result of the detection in this device. The calculation unit 32 calculates the frictional coefficient μ of the tire from Expression (12) using the constants α and β that have been selected and tan δ and E′ calculated by the viscoelastic characteristic calculation unit 11.

### Arrangement Example 2

In the arrangement example 1, the measurement sensor 10 and the viscoelastic characteristic calculation unit 11 shown in FIG. 1 are arranged in the measurement apparatus 100 and the frictional coefficient calculation unit 12 and the insurance premium determination unit 13 are arranged in the server 200. The measurement apparatus 100 is arranged on the road surface R. The input apparatus 300 is connected to the measurement apparatus 100. The server 200 is arranged in a place spaced apart from the measurement apparatus 100 and the input apparatus 300.

In the arrangement example 2 as well, the measurement apparatus 100 outputs, besides the viscoelastic characteristic calculated in the viscoelastic characteristic calculation unit 11, the time at which the frictional coefficient of the tire of the automobile is measured and an ID by which the measurement apparatus 100 can be identified.

Further, as described in the arrangement example 1, in order to accurately calculate the frictional coefficient μ of the tire, it is preferable to correctly determine the constants α and β and tan δ and E′ that depend on the type of the tire. The examples of the method of determining the constants are described in the first and second examples in the arrangement example 1. In either one of the first and second examples, the input apparatus 300 transmits information on the type of the tire that has been acquired to the server 200. The calculation unit 32 of the server 200 selects the constants α and β corresponding to the type of the tire from the plurality of constants α and β stored in the constant storage unit 31 in accordance with the information on the type of the tire that has been acquired. The calculation unit 32 calculates the frictional coefficient μ of the tire using the constants α and β that have been selected and tan δ and E′ calculated by the viscoelastic characteristic calculation unit 11.

Further, the constant storage unit 31 may store information (personal identification information) on each of insured automobiles and the constants α and β of the tire of the automobile so that they are associated with each other. The calculation unit 32 selects the constants α and β in the automobile of the user based on the personal identification information transmitted from the input apparatus 300. The calculation unit 32 calculates the frictional coefficient μ of the tire using the constants α and β that have been selected and tan δ and E′ calculated by the viscoelastic characteristic calculation unit 11.

In the arrangement example 2, the measurement apparatus 100 does not include the frictional coefficient calculation unit 12. Therefore, when a large number of measurement apparatuses 100 are provided, in particular, the cost for the measurement apparatus 100 can be reduced compared to that in the arrangement example 1. When the constant storage unit 31 is updated due to a reason that a new tire will be sold (when values α and β are updated), for example, the measurement apparatus 100 does not need to be updated and only the server 200 may be updated.

### Arrangement Example 3

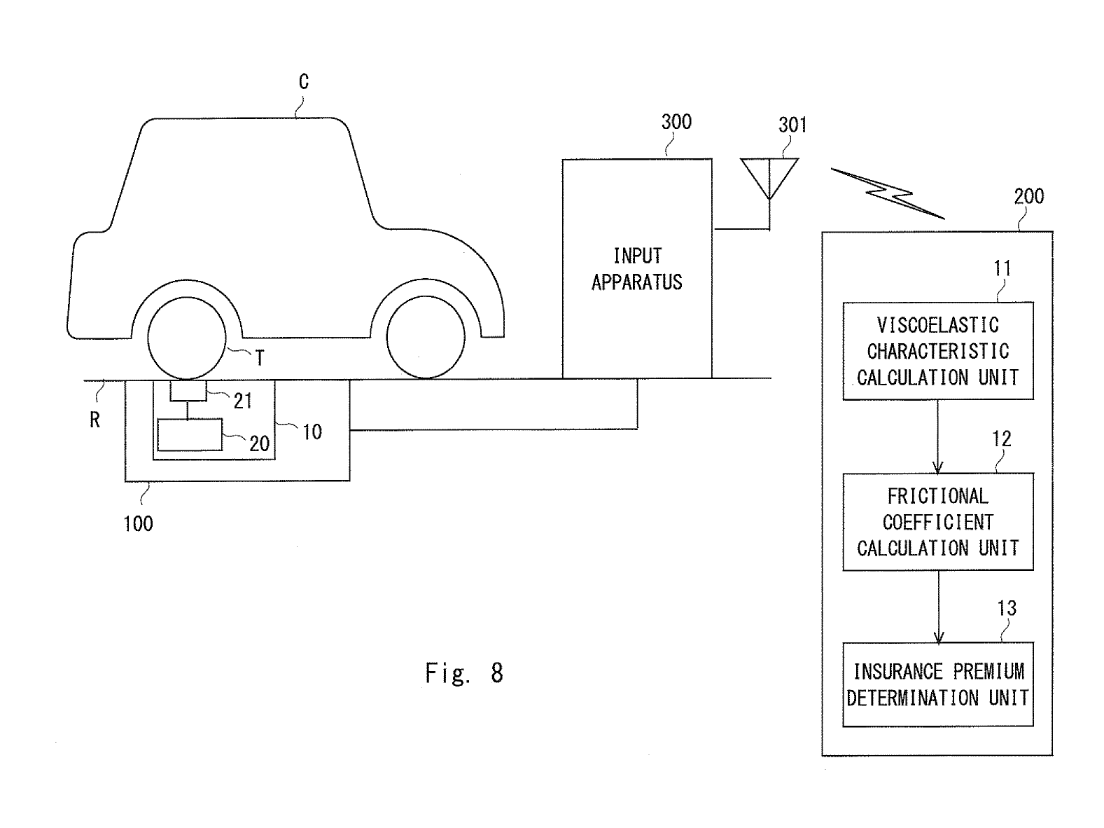

FIG. 8 is a diagram showing an arrangement example 3 of each component of the automobile insurance premium determination system 1. In the arrangement example 3, the measurement sensor 10 shown in FIG. 1 is arranged in the measurement apparatus 100 and the viscoelastic characteristic calculation unit 11, the frictional coefficient calculation unit 12, and the insurance premium determination unit 13 are arranged in the server 200. The measurement apparatus 100 is arranged on the road surface R. The input apparatus 300 is connected to the measurement apparatus 100. The server 200 is located in a place spaced apart from the measurement apparatus 100 and the input apparatus 300.

Since the other processings of each component of the automobile insurance premium determination system 1 have already been described above, descriptions thereof will be omitted. According to the arrangement example 3, the number of functions provided in the measurement apparatus 100 may be reduced compared to those in the arrangement examples 1 and 2, whereby it is possible to further reduce the cost of the measurement apparatus 100.

### Arrangement Example 4

In the aforementioned arrangement examples 1 to 3, the case in which the measurement sensor 10 is provided on the road surface has been described. In an arrangement example 4, a case in which the measurement sensor 10 is arranged in the automobile to be measured will be described. In the arrangement example 4 as well, the viscoelastic characteristic calculation unit 11, the frictional coefficient calculation unit 12, and the insurance premium determination unit 13 are arranged in the server 200 provided in a location spaced apart from the automobile.

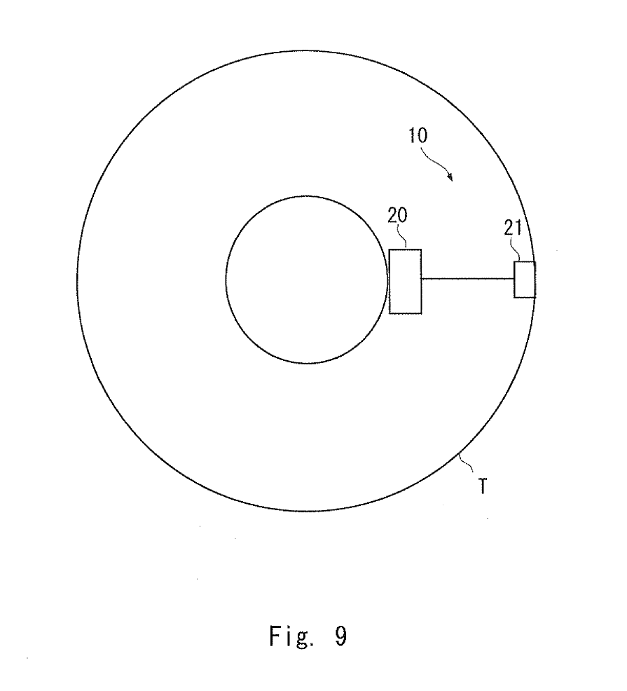

FIG. 9 is a diagram showing one example in which the measurement sensor 10 is provided in the tire T of the automobile. FIG. 9 shows a side view of the tire T. As shown in FIG. 9, by incorporating the measurement sensor 10 into the tire T, the measurement amount of the viscoelastic characteristic of the tire T can be measured. The contact unit 21 in the measurement sensor 10 may be provided, for example, on the rear surface of the tire T and the sound wave signal generation unit 20 may be provided in a rim (wheel) of the tire T.

FIG. 10 is one example of an in-vehicle device provided in the insured automobile according to the arrangement example 4. An in-vehicle device 400 includes, besides the measurement sensor 10, a vehicle information detection apparatus 35, an operating unit 36, and an external communication apparatus 37.

The vehicle information detection apparatus 35 detects the speed, the traveling distance or the like of the automobile on which the in-vehicle device 400 is mounted. This information may be acquired by a sensor provided in a typical automobile. The results of the detection by the measurement sensor 10 and the vehicle information detection apparatus 35 are output to the operating unit 36.

The operating unit 36 includes a vehicle information analysis unit 38, a storage unit 39, and an external communication controller 40. Further, a clock (not shown) capable of acquiring the current time is provided in the operating unit 36. The vehicle information analysis unit 38 records the time elapse of the measurement amount of the tire in the storage unit 39 based on the information output from the measurement sensor 10 and the vehicle information detection apparatus 35 and the result of the count by the clock.

The storage unit 39 stores the personal identification information of the user with the time elapse of the measurement amount of the tire. The external communication controller 40 causes the data of the measurement amount of the tire recorded in the storage unit 39 and the personal identification information to be transmitted to the server 200 by controlling the external communication apparatus 37. The external communication apparatus 37 is, for example, an antenna or the like of a wireless device. When the server 200 receives the data of the measurement amount of the tire, the server 200 calculates the insurance premium of the target automobile in a way similar to that in the arrangement example 3.

The server 200 may calculate the automobile insurance premium using the average value of the data of the measurement amount that has been received or may calculate the automobile insurance premium using the most recent data.

The viscoelastic characteristic calculation unit 11 may be included in the in-vehicle device 400, not in the server 200. Further, the in-vehicle device 400 may further include the frictional coefficient calculation unit 12. When the in-vehicle device 400 includes the frictional coefficient calculation unit 12, the values α and β of the tire used for the automobile are stored in the constant storage unit 31 in advance. The frictional coefficient calculation unit 12 provided in the in-vehicle device 400 may determine whether the frictional coefficient of the tire that has been calculated is equal to or smaller than a predetermined threshold that has been set in advance. When it is determined that the frictional coefficient that has been calculated is equal to or smaller than the predetermined threshold (that is, when the tire is degraded), the in-vehicle device 400 may output alarm information to the user to notify the user that the tire is degraded. The predetermined threshold is a value that is set in advance depending on the type of the tire. According to the aforementioned configuration, the in-vehicle device 400 is able to issue a warning to the user when the tire is degraded regardless of whether the tire of the automobile has been used for a long time or it is a brand new.

In the aforementioned arrangement examples 1 to 4, a case in which the viscoelastic characteristic of the tire is measured when the automobile is equipped with the tire has been described. However, the viscoelastic characteristic of the tire of the automobile may be measured in a way similar to that stated above also when the automobile is not equipped with the tire. The viscoelastic characteristic of the tire may be measured, for example, when the tire is sold. When the viscoelastic characteristic of the tire is already known, the insurance premium may be determined using this viscoelastic characteristic.

### Second Embodiment

Next, a second embodiment of the present invention will be described. In the second embodiment, a processing example of the insurance premium determination unit 13 different from that described in the first embodiment will be described. The descriptions of the parts described in the first embodiment will be omitted.

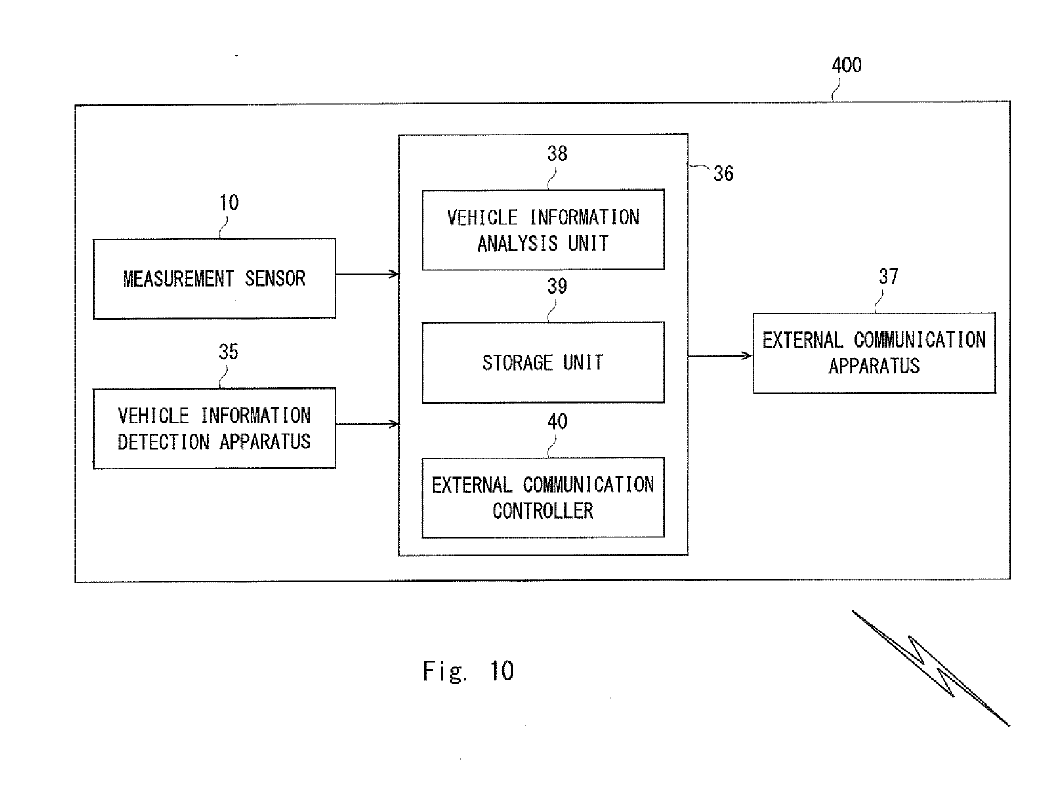

FIG. 11 is a block diagram showing a configuration example of the insurance premium determination unit according to the second embodiment. The insurance premium determination unit 13 in FIG. 11 includes a data storage unit 41, an accident probability estimation unit 42, and a determination unit 43.

The data storage unit 41 stores data indicating a correlation between the frictional coefficient of the tire of the automobile and the probability of the automobile having an accident in advance. This data indicating the correlation is acquired, for example, by carrying out traveling experiments while attaching tires having different frictional coefficients to the same kind of automobiles. Otherwise, this data may be acquired based on statistical data of accidents (data indicating the relevance between the severity of a damage caused by an accident and the frictional coefficient). When the viscoelastic characteristic of the tire is measured in the arrangement examples 1 to 4 in the first embodiment, for example, the server 200 may store the data. After that, by selecting the frictional coefficient of the tire in which an accident has occurred and executing sampling, the data indicating the correlation can be acquired. It is therefore possible to construct a database regarding the frictional coefficient having a sufficient amount of data.

The accident probability estimation unit 42 refers to the data stored in the data storage unit 41 based on the frictional coefficient of the tire calculated by the frictional coefficient calculation unit 12 and estimates the probability of the automobile having an accident regarding the frictional coefficient and the severity of the damage. As the frictional coefficient of the tire decreases, the probability of the accident occurring that is estimated and the severity of the damage are estimated to be high.

The determination unit 43 determines the automobile insurance premium based on the probability of the accident occurring estimated by the accident probability estimation unit 42. As the probability of the accident occurring increases, the insurance premium is calculated to become high. That is, the determination unit 43 calculates the insurance premium so that the insurance premium becomes higher as the frictional coefficient of the tire becomes lower.

As stated above, in the second embodiment, the insurance premium is calculated based on the data indicating the correlation among the frictional coefficient of the tire of the automobile, the probability of the automobile having an accident, and the severity of the damage. It is therefore possible to calculate the insurance premium on which the actual condition is accurately reflected.

### Third Embodiment

Next, a third embodiment according to the present invention will be described. In the following description, the parts already described above will be omitted as appropriate.

In the first embodiment, the insurance premium determination unit 13 determines the automobile insurance premium based on the frictional coefficient of the tire. However, the insurance premium determination unit 13 may determine the automobile insurance premium based on not only the frictional coefficient of the tire but also data of the braking distance of the tire. As stated above, the insurance premium determination unit 13 determines the automobile insurance premium using information on the tire other than the frictional coefficient, whereby it is possible to determine the insurance premium on which the information on the tire is reflected more accurately.

When the braking distance of the automobile in a state in which the ABS is operating (that is, when hard braking of the automobile is applied) is larger than a predetermined value, it can be estimated that the characteristic of the tire is degraded. When a Traction Control System (TCS), which suppresses spinning of the tire through braking, is operating when the automobile is accelerated as well, it can be estimated that the characteristic of the tire is degraded. When the operation frequency of the ABS function or the TCS function is larger than a predetermined value as well, it can be estimated that the characteristic of the tire is degraded. Accordingly, the insurance premium determination unit 13 may determine the automobile insurance premium by using at least one of data of the braking distance of the tire when the ABS function or the TCS function is operating and data of the operation frequency of the ABS function or the TCS function when the automobile has the ABS function or the TCS function together with the frictional coefficient of the tire that has been measured. Even when the automobile does not have the ABS function or the TCS function, the insurance premium determination unit 13 is able to determine the automobile insurance premium using both the data of the braking distance of the tire when the user applies the brakes and the frictional coefficient of the tire that has been measured.

Further, the degradation of the tire also affects a steering angle or a sideslip at the time of turning, a speed control of the automobile in accordance with a lateral acceleration G generated in the vehicle body, and a degree of locking of the tire when the user manually applies the brakes. Therefore, the insurance premium determination unit 13 may determine the automobile insurance premium by using at least one of data of the steering angle at the time of turning of the automobile, data of the sideslip at the time of turning of the automobile, data of the speed control in accordance with the lateral acceleration, and data of the degree of locking of the tire when the user manually applies the brakes together with the frictional coefficient of the tire that has been measured. It is therefore possible to reflect the state of degradation of the tire on the insurance premium more properly.

Further, since the braking force acting on the tire and the lateral acceleration G can be calculated from values measured by an acceleration sensor and a vehicle weight sensor mounted on the automobile (value of the acceleration and the weight of the vehicle), the state of degradation with respect to a reference state of the tire can be accurately determined by normalizing the braking distance and the sideslip due to turning using the braking force and the lateral acceleration G. Further, by performing statistical processing using the measured values of automobiles connected via a network, the normalization of the braking distance when the ABS function or the TCS function is operating, the normalization of the operation frequency of the ABS function or the TCS function, and the normalization of the sideslip due to turning are performed while reflecting the actual condition, which enables a more appropriate determination. The data of the braking distance when the ABS function or the TCS function is operating, the operation frequency of the ABS function or the TCS function, or the sideslip at the time of turning may not only be used to determine the insurance premium but may also be sent to the driver. When the braking distance is equal to or larger than the predetermined threshold and the tire is degraded, for example, the insurance premium determination unit 13 may output alarm information to a user terminal of the automobile (e.g., a mobile terminal such as a smartphone) to notify the user that the tire is degraded.

The insurance premium determination unit 13 acquires data of the braking distance of the tire of the automobile whose insurance premium is to be determined. The automobile whose insurance premium is to be determined may be equipped with a sensor that measures the braking distance when the ABS function or the TCS function is used as an in-vehicle device and this sensor may transmit the data of the braking distance to the server 200 that includes the insurance premium determination unit 13. The method of outputting the data of the in-vehicle device has already been described in the arrangement example 4. The insurance premium determination unit 13 calculates, when the frictional coefficient of the tire calculated by the frictional coefficient calculation unit 12 is constant, the insurance premium so that the insurance premium becomes higher as the braking distance of the tire increases.

The insurance premium table 33 of the insurance premium determination unit 13 may store the values of the frictional coefficient and the braking distance of the tire and the amount of money of the insurance premium in accordance with the values thereof. The insurance premium determination unit 13 is able to determine the insurance premium of the target automobile by referring to the insurance premium table 33 based on the values of the frictional coefficient and the braking distance of the tire and acquiring the amount of money of the insurance premium corresponding to the values of the frictional coefficient and the braking distance.

### Fourth Embodiment

Next, a fourth embodiment according to the present invention will be described. The frictional coefficient of the tire when the frictional coefficient of the tire is measured may not be the same as the frictional coefficient of the tire when the tire is actually used. Since the temperature, the humidity, the road surface state (e.g., whether it snows or not) of the place where the frictional coefficient is measured and those of the place where the automobile is actually used are different from each other, the frictional coefficient of the place where it is measured and the frictional coefficient of the place where the automobile is actually used may be different from each other. Furthermore, depending on the weight of the vehicle of the automobile in a state in which the tire is attached to the automobile, the frictional coefficient when the tire is actually used and the frictional coefficient that has been calculated may be different from each other.

In the above cases, according to the fourth embodiment, the frictional coefficient when the tire is attached to the automobile for use is estimated and the automobile insurance premium is determined based on the frictional coefficient that has been estimated. It is therefore possible to determine the automobile insurance premium on which the safety of the automobile when the tire is actually used is appropriately reflected.

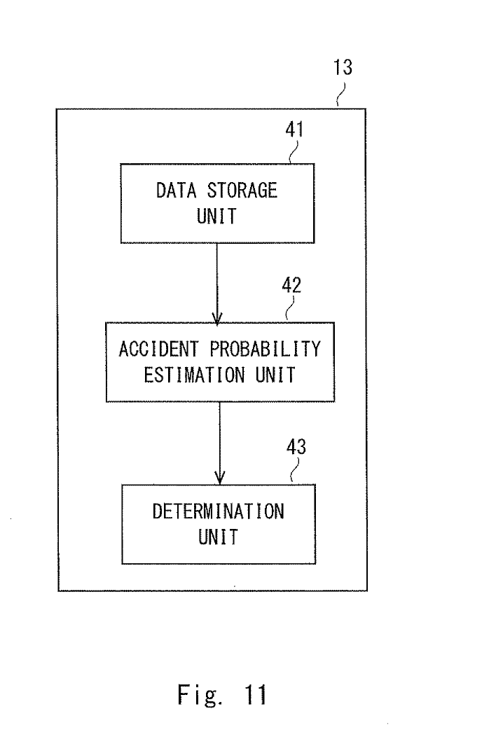

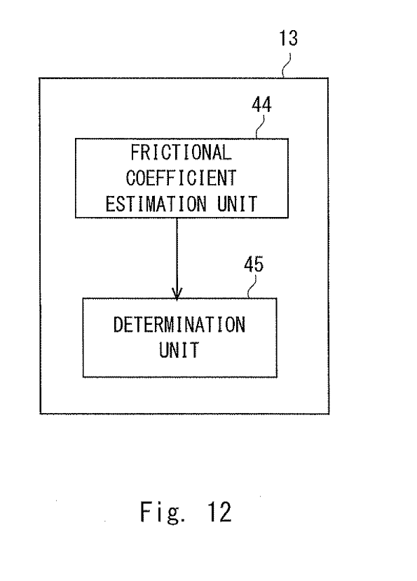

FIG. 12 is a block diagram showing a configuration example of the insurance premium determination unit according to the fourth embodiment. The insurance premium determination unit 13 shown in FIG. 12 includes a frictional coefficient estimation unit 44 and a determination unit 45. The frictional coefficient estimation unit 44 estimates, based on the frictional coefficient of the tire calculated by the frictional coefficient calculation unit 12 and data of the environment in which the tire is actually used, the frictional coefficient in the environment in which the tire is actually used.

The frictional coefficient estimation unit 44 may store, for example, data indicating a rate of change of the frictional coefficient in accordance with a change in temperature. The frictional coefficient estimation unit 44 estimates the frictional coefficient of the tire when the tire is used by referring to the data based on the temperature when the measurement is performed and the temperature when the tire is actually used, acquiring the rate of change of the frictional coefficient when the measurement is performed and the frictional coefficient of the tire when the tire is actually used, and multiplying the frictional coefficient that has been measured by the rate of change.

The determination unit 45 determines the automobile insurance premium based on the frictional coefficient estimated by the frictional coefficient estimation unit 44. Even when the frictional coefficient is changed due to a factor other than the temperature, the insurance premium may be determined by a method similar to that stated above.

### Fifth Embodiment

Next, a fifth embodiment of the present invention will be described. The frictional coefficient when the frictional coefficient calculation unit 12 measures the frictional coefficient of the tire that has not yet been used is considered to be different from the frictional coefficient after the tire is actually used and is worn. In such a case, according to the fifth embodiment, the frictional coefficient after the tire is actually used is estimated and the future automobile insurance premium is determined based on the frictional coefficient that has been estimated. In this way, it is possible to calculate, not only the current insurance premium, but also the future insurance premium in accordance with a traveling distance (e.g., an insurance premium after the next time the insurance is updated). The configuration example of the insurance premium determination unit according to the fifth embodiment has been shown in FIG. 12.

Specifically, the frictional coefficient estimation unit 44 estimates, based on the frictional coefficient of the tire calculated by the frictional coefficient calculation unit 12 and data of the distance which the automobile will travel in the future, the frictional coefficient after the automobile travels this distance. The frictional coefficient estimation unit 44 may store, for example, data indicating the rate of change of the traveling distance and the frictional coefficient. The frictional coefficient estimation unit 44 estimates the frictional coefficient of the tire when the tire is used by referring to the data based on the traveling distance that is estimated, acquiring the rate of change of the frictional coefficient when the measurement is performed and the frictional coefficient of the tire when the tire is actually used, and multiplying the frictional coefficient that has been measured by the rate of change.

The determination unit 45 determines the automobile insurance premium based on the frictional coefficient estimated by the frictional coefficient estimation unit 44. The frictional coefficient estimation unit 44 is able to estimate the frictional coefficient after the traveling of the automobile using, besides the data of the traveling distance, other factors. The frictional coefficient after the traveling of the automobile may also be estimated by using, for example, factors such as the traveling time, the average traveling speed, an environment during the traveling of the automobile, the degree of degradation from a temperature history based on the intensity of traveling of the automobile (speed, change in speed, weight on board), or the degree of degradation over time (in particular, ozone degradation, oxidative degradation, or ultraviolet degradation).

### Sixth Embodiment

Next, a sixth embodiment of the present invention will be described. In the sixth embodiment, the insurance premium of the tire that is currently used is compared with the insurance premium of a new tire when the current tire is replaced.

In the sixth embodiment, the measurement sensor 10 is provided in a place such as a tire shop in which the tire of the automobile is replaced. The measurement sensor 10 measures two kinds of amounts: the amount of the viscoelastic characteristic of the tire of the automobile that is currently being used and the amount of the viscoelastic characteristic of a new tire used after the current tire is replaced.

The viscoelastic characteristic calculation unit 11 calculates, using the amount of the tire that is currently being used and the amount of the new tire used after the current tire is replaced measured by the measurement sensor, the viscoelastic characteristics of the respective tires. The frictional coefficient calculation unit 12 calculates the frictional coefficient of the tire that is currently being used and the frictional coefficient of a new tire used after the current tire is replaced using the viscoelastic characteristic of the tire that is currently being used and the viscoelastic characteristic of the new tire calculated by the viscoelastic characteristic calculation unit 11. The insurance premium determination unit 13 determines, based on the frictional coefficient of each of the tires calculated by the frictional coefficient calculation unit 12, the automobile insurance premium when the tire that is currently being used is used and the automobile insurance premium of a new tire used after the current tire is replaced. Since the details of the processing in regard to each component have already been described above in the first embodiment and the like, descriptions thereof will be omitted. When the user replaces the tire of the automobile, the tire to be newly used may be a used tire or may have been stored under poor conditions. Accordingly, by checking the freshness (or the state of degradation) of the tire to be newly used by the insurance company or the like, the right amount of insurance premium can be set.

As described above, in the sixth embodiment, when the tire is replaced, the automobile insurance premium when the tire that is currently being used is used and the automobile insurance premium of a new tire used after the current tire is replaced can be calculated. The insurance premium determination unit 13 may output, for example, the insurance premiums calculated above to the terminal in the tire shop and the salesperson of the shop may show the user of the automobile the insurance premiums displayed on the terminal, whereby it is possible to easily notify the user that the amount of money of the insurance premium can be reduced by purchasing tires. Furthermore, the purchase of tires is promoted, which results in yielding a profit for the shop as well.

### Seventh Embodiment

In a seventh embodiment, a part of the tire measured by the measurement sensor 10 will be specified. In the first embodiment, the tire measured by the measurement sensor 10 is an arbitrary one of a plurality of wheels of the automobile. However, depending on the characteristic of the automobile, there is a tire among a plurality of tires that is easily worn or there is a part in one tire that particularly tends to be worn. In the seventh embodiment, a measurement method in consideration of such an actual condition will be described.

When the automobile whose insurance premium is to be calculated is a front-wheel-drive vehicle, since a braking force and a driving force are intensively applied to front-wheel tires (front tires), the front-wheel tires tend to be easily worn compared to rear-wheel tires (rear tires). Therefore, by causing the measurement sensor 10 to come into contact with the front-wheel tires that tend to be worn and measuring the viscoelastic characteristic thereof, it may be possible to calculate the insurance premium on which the degree of risk of the automobile is reflected more properly. In contrast, when the automobile whose insurance premium is to be calculated is a rear-wheel-drive vehicle, the rear-wheel tires tend to be easily worn compared with the front-wheel tires. Therefore, by causing the measurement sensor 10 to come into contact with the rear-wheel tires that tend to be worn and measuring the viscoelastic characteristic thereof, it may be possible to calculate the insurance premium on which the degree of risk of the automobile is reflected more properly.

Further, in the front-wheel tire, a shoulder part (respective ends of a tread pattern of the tire) tends to be worn and in the rear-wheel tire, a center part of a tread pattern tends to be worn. Accordingly, by causing the measurement sensor 10 to come into contact with the part of the tire that tends to be worn and measuring the viscoelastic characteristic thereof, it may be possible to calculate the insurance premium on which the degree of risk of the automobile is reflected more properly, similar to the aforementioned case.

The tire of the automobile and the part of the tire that tends to be worn may vary depending on the characteristic or the like of the driving by the user. In such a case, it may be possible to cause the measurement sensor 10 to come into contact with the part that is particularly worn (or the part that is estimated to be easily worn) and perform measurement of the viscoelastic characteristic thereof.

Note that the present invention is not limited to the aforementioned embodiments and may be changed as appropriate without departing from the spirit of the present invention. The embodiments stated above may be, for example, combined as appropriate.

In the arrangement examples 1 to 4 in the first embodiment, the measurement apparatus 100 may measure the characteristics of the tire other than the viscoelastic characteristic. The measurement apparatus 100 may further include, for example, an air pressure measurement sensor that measures the air pressure of the tire. The insurance premium determination unit 13 is able to determine the insurance premium based on the frictional coefficient calculated by the frictional coefficient calculation unit 12 and the air pressure of the tire. The insurance premium table 33 of the insurance premium determination unit 13 stores, for example, the values of the frictional coefficient and the air pressure of the tire and the amount of money of the insurance premium corresponding to the values of the frictional coefficient and the air pressure of the tire. The determination unit 34 is able to determine the insurance premium of the target automobile by referring to the insurance premium table 33 based on the values of the frictional coefficient and the air pressure of the tire and acquiring the amount of money of the insurance premium corresponding to the values of the frictional coefficient and the air pressure. It is therefore possible to calculate the insurance premium on which the maintenance situation of the tire is appropriately reflected. The method of determining the amount of money of the insurance premium using the air pressure is not limited to the method stated above and a method similar to the method described above can be employed. The characteristics of the tire other than the viscoelastic characteristic measured by the measurement apparatus 100 are not limited to the air pressure.

An optical sensor may be provided in the contact unit 21 in place of the contact sensor 27. The optical sensor detects that the tire has come into contact with the contact unit 21 by detecting light shielding by the tire and outputs a detection signal to the operating unit 30. In a similar way, another type of sensor such as a proximity sensor that detects that the tire has come into contact with the contact unit 21 may be provided in the contact unit 21. As described above, it is preferable that a desired sensor be provided in the contact unit 21 in order to detect that the tire has come into contact with the contact unit 21 and to accurately measure the viscoelastic characteristic of the tire.

However, it may not be necessary to provide the contact sensor 27. A switch to start measuring the viscoelasticity of the tire may be provided, for example, in an input terminal connected to the measurement apparatus 100 and the operating unit 30 may start the measurement of the measurement sensor 10 when the user of the automobile pushes the switch.

The method of measuring the viscoelastic characteristic of the tire is not limited to the aforementioned sound wave reflection method and another method may be employed. A transmission method in which a sound wave is transmitted through the tire and the sound wave after the transmission is measured may be, for example, used. The sound wave that has been transmitted is converted into an electric signal by a transducer, whereby the viscoelastic characteristic of the tire can be measured in a way similar to the case in which the sound wave reflection method is used.

This application is based upon and claims the benefit of priority from Japanese Patent Application No. 2014-142268, filed on Jul. 10, 2014, the disclosure of which is incorporated herein in its entirety by reference.

### REFERENCE SIGNS LIST

1 AUTOMOBILE INSURANCE PREMIUM DETERMINATION SYSTEM
10 MEASUREMENT SENSOR
11 VISCOELASTIC CHARACTERISTIC CALCULATION UNIT
12 FRICTIONAL COEFFICIENT CALCULATION UNIT
13 INSURANCE PREMIUM DETERMINATION UNIT
20 SOUND WAVE SIGNAL GENERATION UNIT
21 CONTACT UNIT
22 DRIVE WAVEFORM GENERATOR
23 DIRECTION REGULATOR
24 HIGH-FREQUENCY AMPLIFIER
25 TRANSDUCER
26 DELAY MEMBER
27 CONTACT SENSOR
28 TIME DATA MEMORY UNIT
29 REFERENCE VALUE STORAGE UNIT
30 OPERATING UNIT
31 CONSTANT STORAGE UNIT
32 CALCULATION UNIT
33 INSURANCE PREMIUM TABLE
34 DETERMINATION UNIT
35 VEHICLE INFORMATION DETECTION APPARATUS
36 OPERATING UNIT
37 EXTERNAL COMMUNICATION APPARATUS
38 VEHICLE INFORMATION ANALYSIS UNIT
39 STORAGE UNIT
40 EXTERNAL COMMUNICATION CONTROLLER
41 DATA STORAGE UNIT
42 ACCIDENT PROBABILITY ESTIMATION UNIT
43 DETERMINATION UNIT
44 FRICTIONAL COEFFICIENT ESTIMATION UNIT
45 DETERMINATION UNIT
100 MEASUREMENT APPARATUS
200 SERVER
300 INPUT APPARATUS
301 RADIO TRANSMISSION UNIT
400 IN-VEHICLE DEVICE

1. An automobile insurance premium determination system comprising:
a measurement sensor that measures a measurement amount of a viscoelastic characteristic of a tire of an automobile;
a viscoelastic characteristic calculation unit that calculates the viscoelastic characteristic of the tire using the measurement amount measured by the measurement sensor;
a frictional coefficient calculation unit that calculates a frictional coefficient of the tire using the viscoelastic characteristic calculated by the viscoelastic characteristic calculation unit; and
an insurance premium determination unit that determines an automobile insurance premium based on the frictional coefficient of the tire calculated by the frictional coefficient calculation unit.

2. The automobile insurance premium determination system according to claim 1, wherein:
the measurement sensor comprises:
an emission unit that emits an incident sound wave to the tire; and
a reception unit that receives a reflected sound wave generated as a result of reflection of the incident sound wave emitted from the emission unit in the tire, and
the viscoelastic characteristic calculation unit calculates the viscoelastic characteristic of the tire based on the reflected sound wave received by the reception unit.

3. The automobile insurance premium determination system according to claim 1, wherein:
the measurement sensor is provided in a place where the automobile stops, and
the insurance premium determination unit is provided in a server that is located spaced apart from the measurement sensor.

4. The automobile insurance premium determination system according to claim 1, wherein the insurance premium determination unit determines the automobile insurance premium using, together with the frictional coefficient of the tire, data of at least one of a braking distance of the tire, a steering angle at the time of turning of the automobile, a sideslip at the time of turning of the automobile, a speed control in accordance with a lateral acceleration of the automobile, and a degree of locking of the tire when brakes in the automobile are applied.

5. The automobile insurance premium determination system according to claim 1, wherein the insurance premium determination unit determines the automobile insurance premium using, together with the frictional coefficient of the tire, data of at least one of a braking distance of the automobile when an ABS (Antilock Brake System) function or a TCS (Traction Control System) function is operating in the automobile and an operation frequency of the ABS function or the TCS function of the automobile.

6. The automobile insurance premium determination system according to claim 1, wherein the insurance premium determination unit comprises:
a data storage unit that stores data indicating a correlation between the frictional coefficient of the tire of the automobile and a probability of occurrence of an accident of the automobile in advance;
an accident probability estimation unit that refers to the data stored in the data storage unit and estimates the probability of the occurrence of the accident of the automobile based on the frictional coefficient of the tire calculated by the frictional coefficient calculation unit; and
a determination unit that determines the automobile insurance premium based on the probability of the occurrence of the accident estimated by the accident probability estimation unit.

7. The automobile insurance premium determination system according to claim 1, wherein the insurance premium determination unit comprises:
a frictional coefficient estimation unit that estimates, based on the frictional coefficient of the tire calculated by the frictional coefficient calculation unit and data of an environment in which the tire is actually used, the frictional coefficient in the environment in which the tire is actually used; and
a determination unit that determines the automobile insurance premium based on the frictional coefficient estimated by the frictional coefficient estimation unit.

8. The automobile insurance premium determination system according to claim 1, wherein the insurance premium determination unit comprises:
a frictional coefficient estimation unit that estimates, based on the frictional coefficient of the tire calculated by the frictional coefficient calculation unit and data of a distance which the automobile is expected to travel in the future, the frictional coefficient after the automobile travels the distance; and
a determination unit that determines the automobile insurance premium based on the frictional coefficient estimated by the frictional coefficient estimation unit.

9. The automobile insurance premium determination system according to claim 1, wherein:
the measurement sensor measures the measurement amount of the tire of the automobile that is currently being used and the measurement amount of the tire to be newly used,
the viscoelastic characteristic calculation unit calculates viscoelastic characteristics of the two kinds of tires using the measurement amounts of the two kinds of tires measured by the measurement sensor,
the frictional coefficient calculation unit calculates frictional coefficients of the two kinds of tires using the viscoelastic characteristics of the two kinds of tires calculated by the viscoelastic characteristic calculation unit, and
the insurance premium determination unit separately determines, based on the frictional coefficients of the two kinds of tires calculated by the frictional coefficient calculation unit, insurance premiums of the automobile when the two kinds of tires are used.

10. An automobile insurance premium determination method comprising:
a measurement step that measures a measurement amount of a viscoelastic characteristic of a tire of an automobile;
a viscoelastic characteristic calculation step that calculates the viscoelastic characteristic of the tire using the measurement amount that has been measured;
a frictional coefficient calculation step that calculates a frictional coefficient of the tire using the viscoelastic characteristic that has been calculated; and
an insurance premium determination step that determines an automobile insurance premium based on the frictional coefficient of the tire that has been calculated.
